(19) United States
(12) Patent Application Publication
(10) Pub. No.: US 2015/0090741 A1
(43) Pub. Date: Apr. 2, 2015

(54) Compression Spring and Pump for Dispensing Fluid

(71) Applicant: DDPS GLOBAL, LLC, St. Joseph, MO (US)

(72) Inventor: Martin S. Laffey, St. Joseph, MO (US)

(21) Appl. No.: 14/387,346

(22) PCT Filed: Mar. 25, 2013
(86) PCT No.: PCT/US13/33739

§ 371 Date: Sep. 23, 2014

Related U.S. Application Data
(60) Provisional application No. 61/614,722, filed on Mar. 23, 2012.

(51) Int. Cl. B05B 11/00; F16F 3/087

(52) U.S. Cl. CPC B05B 11/3077; F16F 3/0876
USPC 222/341; 267/158; 264/328.1; 222/321.9

(57) ABSTRACT

Springs having various configurations include upper and lower connecting members and spring elements extending therebetween. The configurations of the springs may enable them to be formed of polymeric material such as by injection molding. Pumps for pumping fluid or adapted for other uses may include such springs and may include interfacing arrangements with the springs.

### FIELD OF THE INVENTION

The present disclosure generally relates to springs and more particularly compression springs. The present disclosure also generally relates to pumps and more particularly pumps for dispensing fluid.

### BACKGROUND OF THE INVENTION

Compression springs are used in countless applications to bias various components away from each other. For example, compression springs may be used in pumps for dispensers such as fluid dispensers. Some such fluid dispensers include lotion or soap dispensers (e.g., countertop hand lotion dispensers), cleanser dispensers (e.g., hand-held glass cleaner dispensers), and dispensers for liquid detergents, cosmetics, perfumes, medicine, and food. In general, the pumps include an actuator having unactuated and actuated positions. The springs bias the actuators toward the unactuated position, and when the actuator is moved from the unactuated position to the actuated position, fluid is dispensed from an outlet of the dispenser. Compression springs may be used in other applications such as in biasing valve members toward open or closed positions. One type of a conventional compression spring is an upright helical spring which includes a piece of wire configured to define a helix having several turns or coils along a height of the helix rising at a constant upward angle. The end coils may be closed to form substantially circular closed end coils which lie in parallel spaced-apart planes and are perpendicular to the longitudinal axis of the spring. Other types of conventional springs may also be used, such as bellows springs.

### SUMMARY

In a first aspect a spring includes first and second spring elements. The first spring element extends between first and second ends of the spring on a first side of the spring. The first spring element defines a first concave segment opening in a first direction. The second spring element extends between the first and second ends of the spring on a second side of the spring. The second spring element defines a first concave segment opening in a second direction generally opposite the first direction.

In another aspect, a spring includes upper and lower support members defining respective upper and lower bearing surfaces and at least first and second spring elements extending between the upper and lower support members. The spring further comprises at least one brace connecting the first spring element to the second spring element.

In yet another aspect, a pump for dispensing fluid comprises a spring and structure which houses the spring. The spring includes spring elements having side engagement surfaces. The structure has corresponding engagement surfaces for engaging respective engagement surfaces of the spring elements for substantially preventing the spring elements from bulging radially outward when the spring elements are compressed.

In yet another aspect, a method of forming a spring such as those claimed above uses a single close-and-open injection molding step.

In yet another aspect, a pump for dispensing fluid comprises a spring and a lost motion connection which compensates for reduction of length or reduction of resiliency of the spring.

In yet another aspect, a pump for dispensing fluid comprises a spring and components which define corresponding structure for locking and unlocking the pump, wherein the corresponding structure includes a camming surface.

In yet another aspect, a spring includes a generally cylindrical hollow body having hinges about which opposite vertical sections of the body are pivotable toward each other to form the generally cylindrical shape of the body.

Other features and aspects of the present invention will in part be apparent and in part be pointed out hereinafter.

### BRIEF DESCRIPTION OF THE DRAWINGS

FIG. 1 is a left front perspective of a pump showing an actuator of the pump in a locked position;

FIG. 2 is an exploded view of the pump of FIG. 1;

FIG. 3 is a perspective of the pump similar to the view of FIG. 1 but showing the actuator rotated to an unlocked position;

FIG. 4 is a left side elevation of the pump;

FIG. 5 is a right bottom perspective of the actuator;

FIG. 6 is a front perspective of a piston and chaplet of the pump;

FIG. 7 is a horizontal section of the pump taken in the plane including line 7-7 in FIG. 3, the valve being shown in the unlocked position;

FIG. 8 is a top view of the section of FIG. 7;

FIG. 9 is a horizontal section of the pump taken in the plane including line 9-9 in FIG. 1, the valve being shown in the locked position;

FIG. 10 a top view of the section of FIG. 9;

FIG. 11 is a vertical section of the pump taken in the plane including line 11-11 in FIG. 3, the valve being shown in the unlocked position and the actuator being shown in an unactuated position;

FIG. 12 is a horizontal section of the pump taken in the plane including line 12-12 in FIG. 4;

FIG. 13 is a bottom perspective of the actuator with the spring on the actuator;

FIG. 14 is a bottom view of the actuator and spring of FIG. 13;

FIG. 15 is a vertical section similar to the view of FIG. 11 but having the actuator shown in an actuated position;

FIG. 16 is a vertical section of the pump taken in the plane including line 16-16 in FIG. 3, the actuator being shown in the actuated position;

FIGS. 17A-17E illustrate various views of the spring of FIG. 2 in a relaxed position;

FIGS. 18A-18D illustrate various views of the spring in a compressed position, the spring being shown schematically;

FIGS. 19A-19C illustrate enlarged views of a housing, piston shaft, and piston member, the piston shaft and piston member being shown in different positions which result from actuation of the actuator;

FIGS. 20A-20E illustrate a second embodiment of a spring of the present invention;

FIGS. 21A-21E illustrate a third embodiment of a spring of the present invention;

FIGS. 22A-22E illustrate a fourth embodiment of a spring of the present invention;

FIGS. 23A-23E illustrate a fifth embodiment of a spring of the present invention;

FIGS. 24A-24E illustrate a sixth embodiment of a spring of the present invention;

FIGS. 25A-25E illustrate a seventh embodiment of a spring of the present invention;

FIGS. 26A-26E illustrate an eighth embodiment of a spring of the present invention;

FIGS. 27A-27E illustrate a ninth embodiment of a spring of the present invention;

FIGS. 28A-28F illustrate a tenth embodiment of a spring of the present invention;

FIGS. 29A-29F illustrate an eleventh embodiment of a spring of the present invention;

FIG. 30 illustrates a second embodiment of a pump according to the present invention;

FIG. 31 is an exploded view of the pump of FIG. 30;

FIG. 32 is a bottom perspective of an actuator of the pump;

FIG. 33 is a perspective of a piston and chaplet of the pump;

FIG. 34A is an elevation of the actuator on the chaplet showing the actuator in a locked position;

FIG. 34B is an elevation of the actuator and chaplet similar to FIG. 34A but showing the actuator in an unlocked, unactuated position;

FIG. 34C is an elevation of the actuator and chaplet similar to FIG. 34B but showing the actuator in an unlocked, actuated position;

FIG. 34D is an elevation of the actuator and chaplet similar to FIG. 34B but simulating the spring of the pump having a decreased length such that the actuator is supported by the spring in a lower position than in FIG. 34B;

FIG. 35 is a perspective of a third embodiment of a pump of the present invention;

FIG. 36 is an exploded view of the pump of FIG. 35;

FIG. 37 is a bottom perspective of an actuator of the pump;

FIG. 38 is a vertical section of a housing of the pump showing a contoured surface of the housing;

FIG. 39A is an elevation of the actuator and housing, portions of the housing being broken away to expose the contoured surface of the housing, the actuator being shown in a locked position;

FIG. 39B is an elevation similar to FIG. 39A but showing the actuator in an unlocked, unactuated position;

FIG. 40 is a perspective of a fourth embodiment of a pump of the present invention;

FIG. 41 is an exploded view of the pump of FIG. 40;

FIG. 42 is a bottom perspective of an actuator of the pump;

FIG. 43 is a perspective of a reservoir cap of the pump;

FIG. 44 is a plan view of the pump;

FIG. 45A is a section taken in the plane including line 45-45 shown in FIG. 44, the actuator being shown in a locked position, a portion of the actuator being broken away to expose a slot of a contoured surface in the actuator;

FIG. 45B is a section similar to FIG. 45A but showing the actuator in an unlocked, unactuated position; and

FIGS. 46A-46E illustrate a twelfth embodiment of a spring of the present invention.

Corresponding reference characters indicate corresponding parts throughout the drawings.

### DETAILED DESCRIPTION

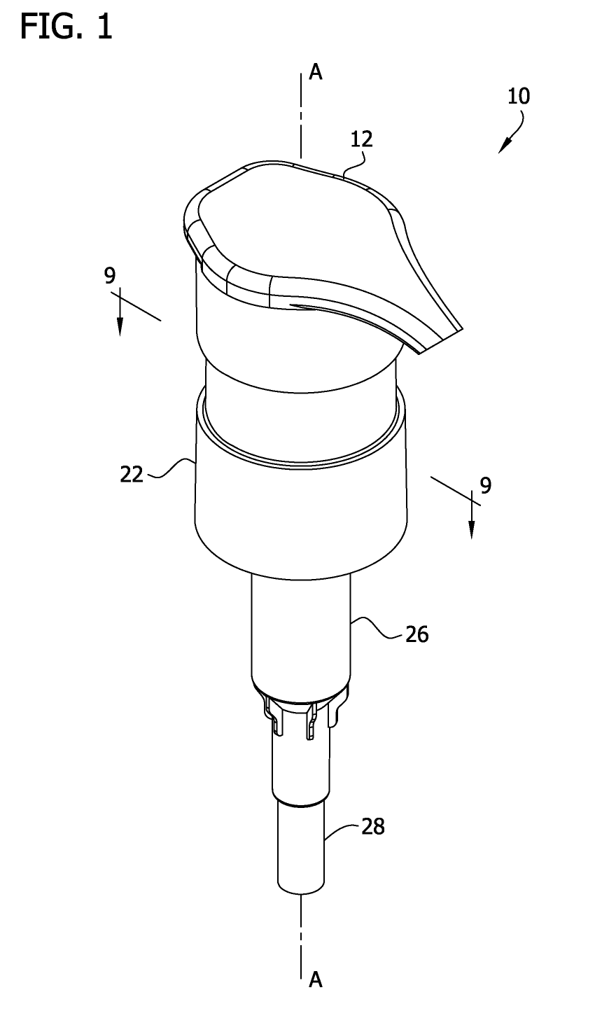

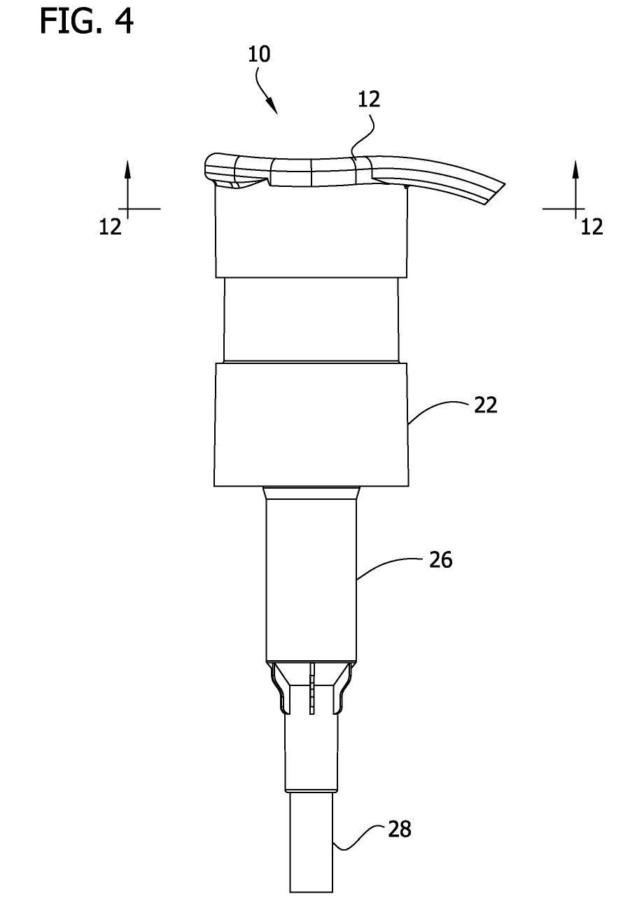

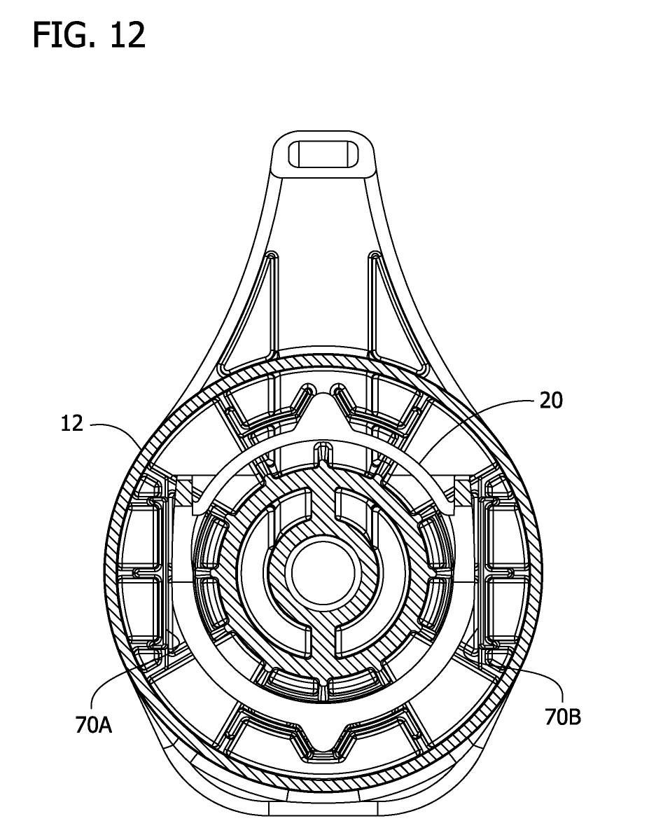

Referring to FIGS. 1-16, a pump constructed according to principles of the present invention is designated generally by the reference number 10. The pump may be adapted for mounting on a reservoir for forming a dispenser. Numerous types of such reservoirs are known in the art and are not illustrated herein. In general, a fluid to be dispensed is stored in the reservoir, and the pump 10 is configured for pumping the fluid out of the reservoir for dispensing the fluid as desired. For example, the illustrated pump 10 may be mounted on a suitable reservoir for forming a lotion or soap dispenser. The pump 10 may be used for dispensing other types of fluids without departing from the scope of the present invention.

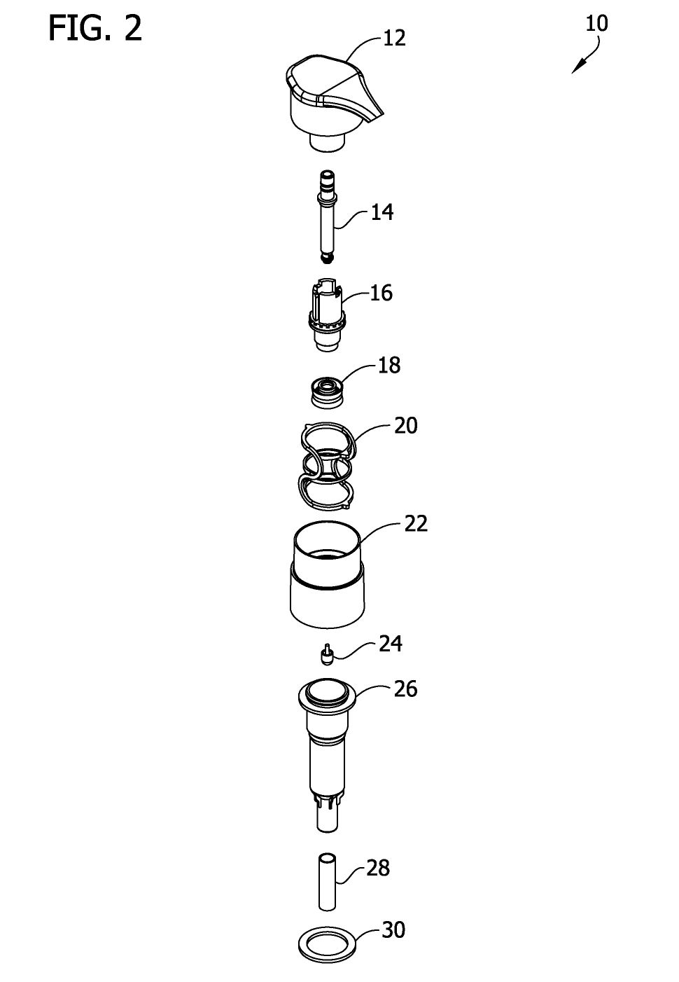

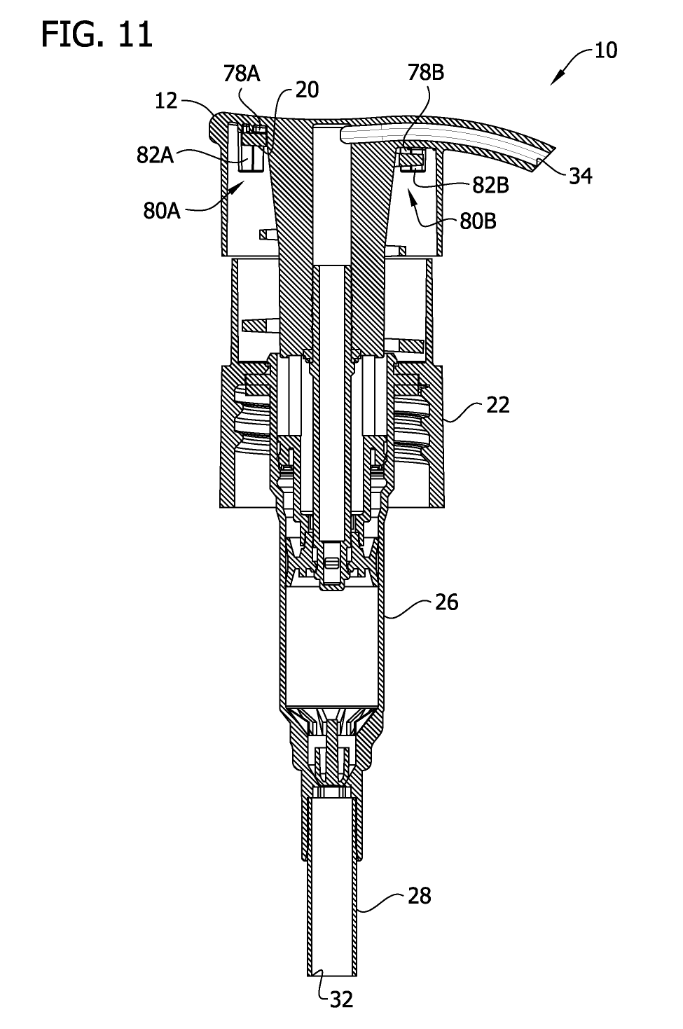

As shown in FIG. 2, the pump 10 includes several different parts. More specifically, the pump 10 includes, as shown from top to bottom, an actuator 12, a piston shaft 14, a chaplet 16, a piston member 18, a compression spring 20, a reservoir cap 22, a check valve 24, a piston housing 26, a dip tube 28, and a gasket 30. As shown in FIG. 11, the pump 10 has an inlet 32 positioned at a distal end of the dip tube and an outlet 34 positioned on a nozzle on the actuator. The actuator 12 and reservoir cap 22 at least partially define a housing which houses the spring 20 and conceals the spring from view. The pump 10 has a vertical axis indicated by the line A-A in FIG. 1. As will be explained in further detail below, the actuator 12 may be selectively actuated against a biasing force of the spring 20 to dispense fluid.

The pump 10 of the present invention includes features which permit more efficient construction of the pump, reduce cost associated with construction of the pump, and enhance recyclability of the pump. The spring 20 may be formed substantially entirely of a non-metal material. For example, the spring 20 may be formed of a plastic material or thermoplastic polymer such as acetel or polypropylene. Desirably, the spring 20 has a construction which permits formation of the spring in a single close-and-open injection molding step (i.e., not requiring slides for additional injection molding steps). Use of such materials and relatively simple injection-molding techniques enhances efficiency of construction and manufacturing and decreases construction costs. The other components which make up the pump 10 may also be made of similar material to facilitate recycling of the pump. Springs formed of plastic material may not provide desired biasing force or have the necessary operating life unless suitably structured. The springs of the present invention include structure designed specifically for permitting use of plastic material in forming a spring which has sufficient biasing force for use in a pump of the type contemplated. Moreover, the pump 10 may include other features, which will become apparent, which cooperate with the spring 20 for assisting the spring in providing the desired biasing force. The components of the pump 10, including the spring 20, may be made of other materials and formed in other ways (e.g., using multiple-step injection molding operations) without departing from the scope of the present invention.

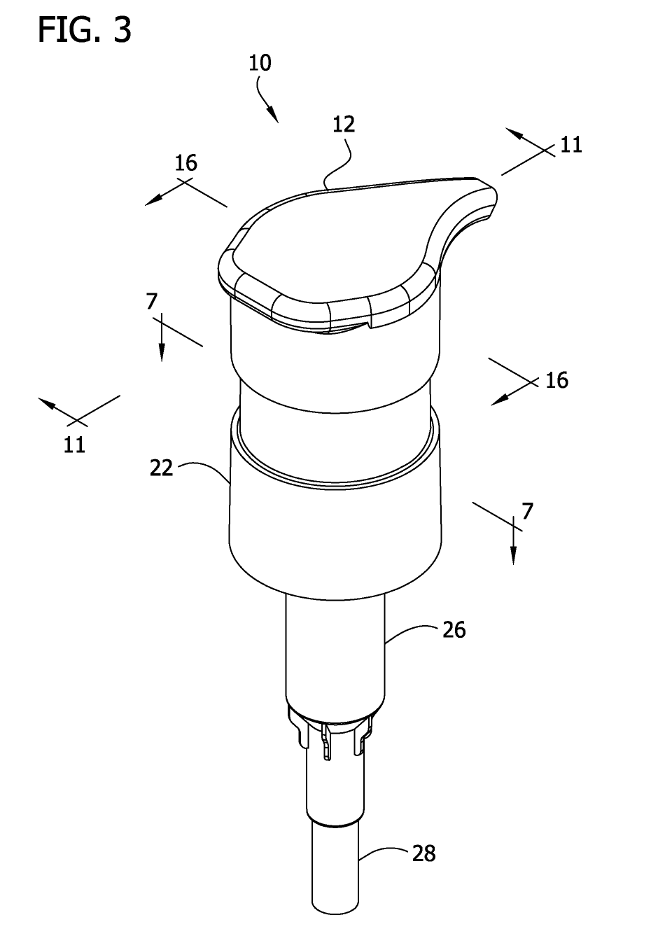

The illustrated pump 10 may be unlocked and locked by rotating the actuator 12 between unlocked and locked rotational positions, and when the actuator is in the unlocked position, the actuator may be moved vertically between an upper, unactuated position and a lower, actuated position to dispense liquid. FIG. 1 illustrates a left front perspective of the pump 10 in which the actuator 12 is in the locked position. FIG. 3 also illustrates a left front perspective of the pump 10 but the actuator 12 has been rotated about 90 degrees counter-clockwise to the unlocked position. Other degrees of rotation may be used for moving the actuator 12 between the locked and unlocked positions without departing from the scope of the present invention. As will be explained in further detail below, the spring 20 and actuator 12 include mating structure which causes the spring to rotate about the vertical axis A-A of the pump conjointly with the actuator.

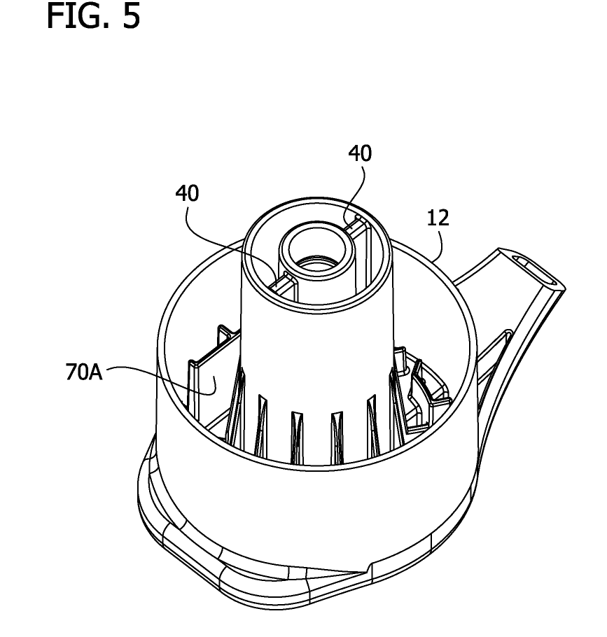

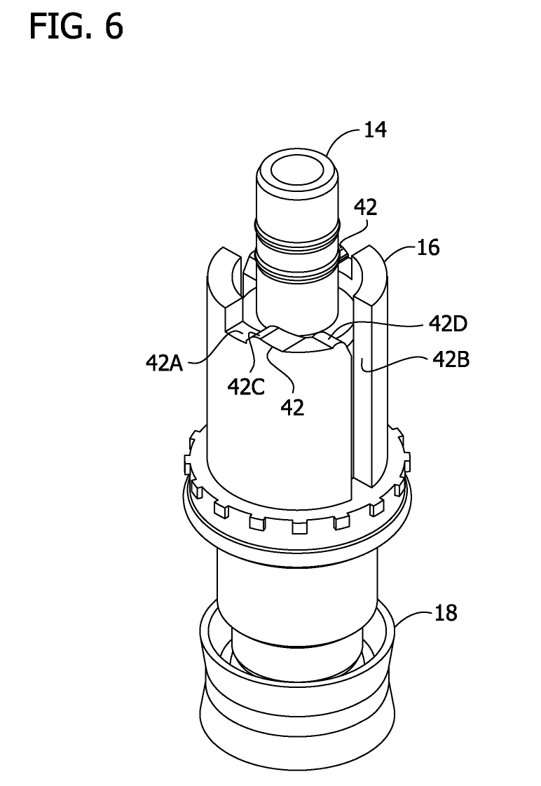

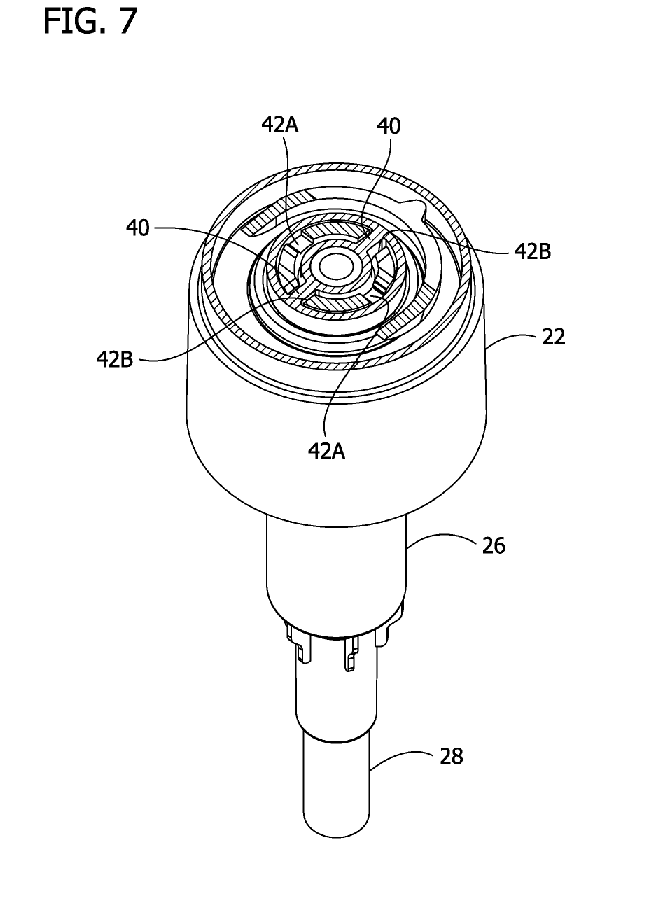

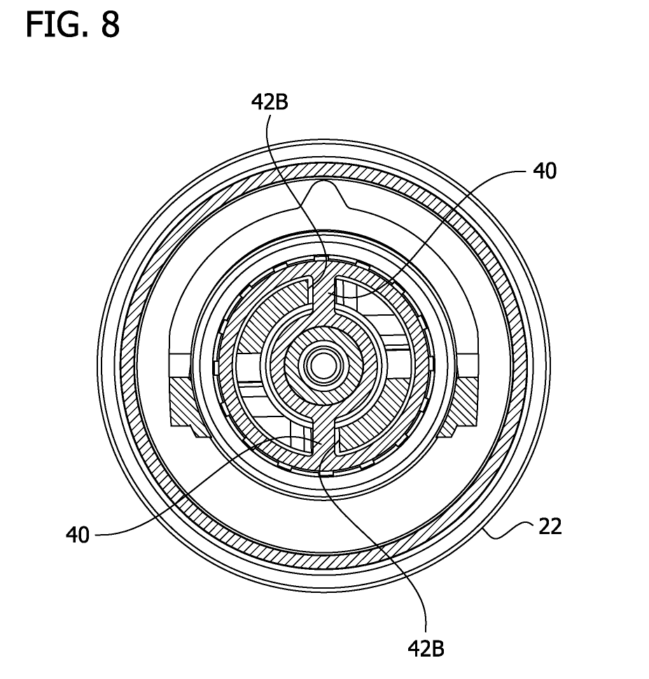

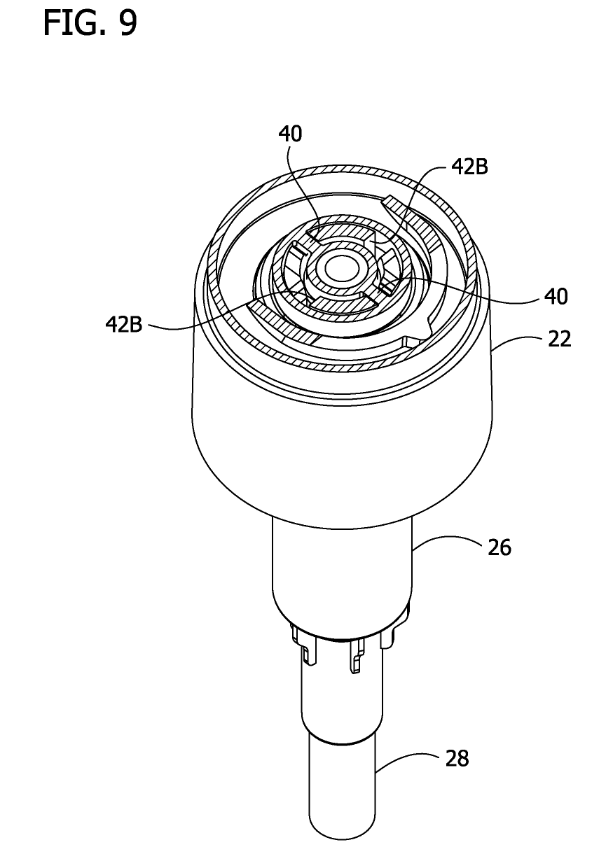

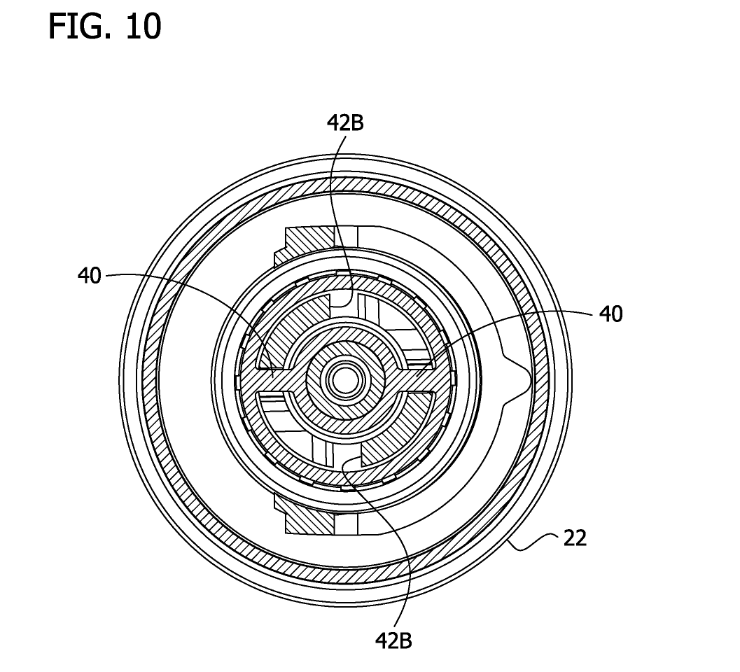

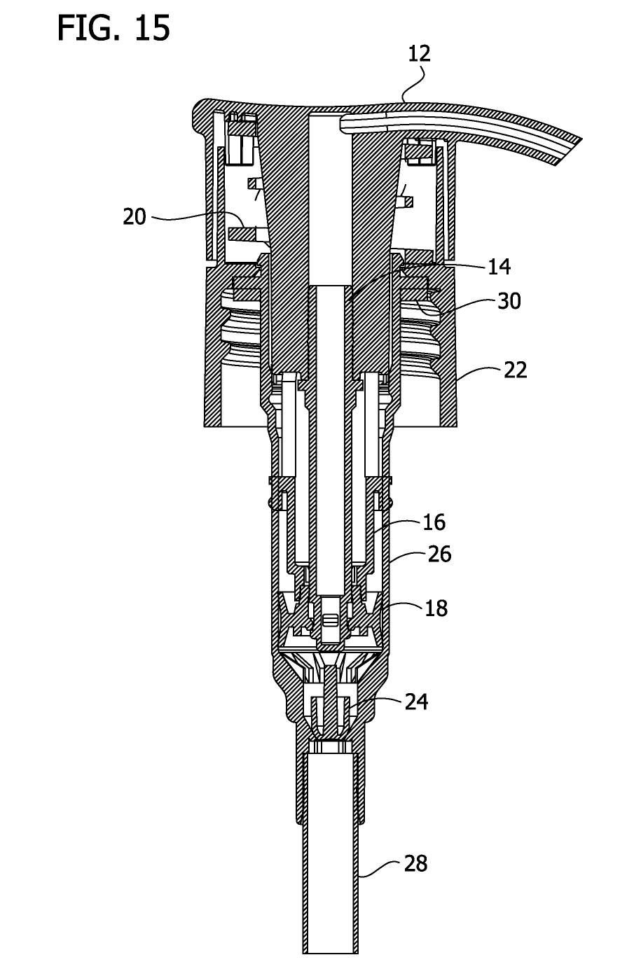

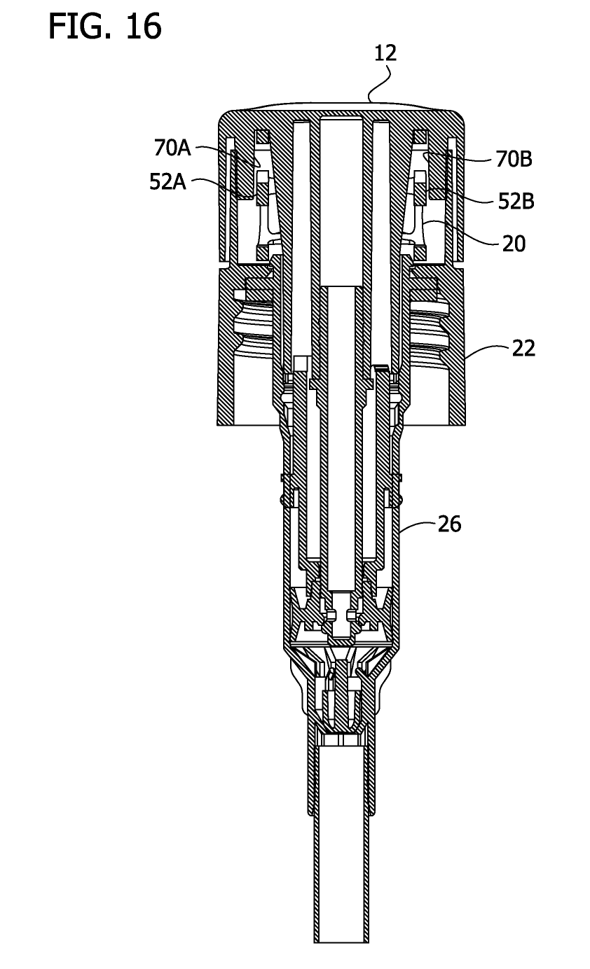

Components of the pump may include cooperating structure which “locks” the pump when the actuator is in the locked position and “unlocks” the pump when the actuator is in the unlocked position. For example, in the illustrated embodiment, the actuator 12 and the chaplet 16 include cooperating structure which “locks” the pump when the actuator is in the locked position and “unlocks” the pump when the actuator is in the unlocked position. As shown in FIG. 5, a bottom perspective of the actuator 12, the actuator includes ribs 40 extending radially outward from a vertical axis of the actuator. As shown in FIG. 6, a perspective of the chaplet 16, piston shaft 14, and piston member 18, the chaplet includes opposite contoured upward facing surfaces 42, for engaging the ribs of the actuator. Each contoured surface includes a first portion or notch 42A in which a respective rib 40 is received when the actuator is in the locked position, a second portion or slot 42B in which the rib is received when the actuator is in the unlocked position, and respective first and second detents 42C, 42D adjacent the notch and slot. FIGS. 7 and 8 illustrate a horizontal section of the pump 10 in which the actuator 12 is in the unlocked position. FIGS. 9 and 10 illustrate a horizontal section of the pump 10 in which the actuator 12 is in the closed position. The slots 42B in the chaplet 16 have a height for receiving the ribs 40 of the actuator 12 so that the actuator may be moved from an unactuated position (e.g., FIGS. 3 and 11) downward to an actuated position (e.g., FIGS. 15 and 16) to cause the piston to move fluid through the pump. As illustrated in later embodiments, components of the pump 10 other than the actuator 12 and the chaplet 16 may include cooperating structure for “locking” and “unlocking” the pump without departing from the scope of the present invention.

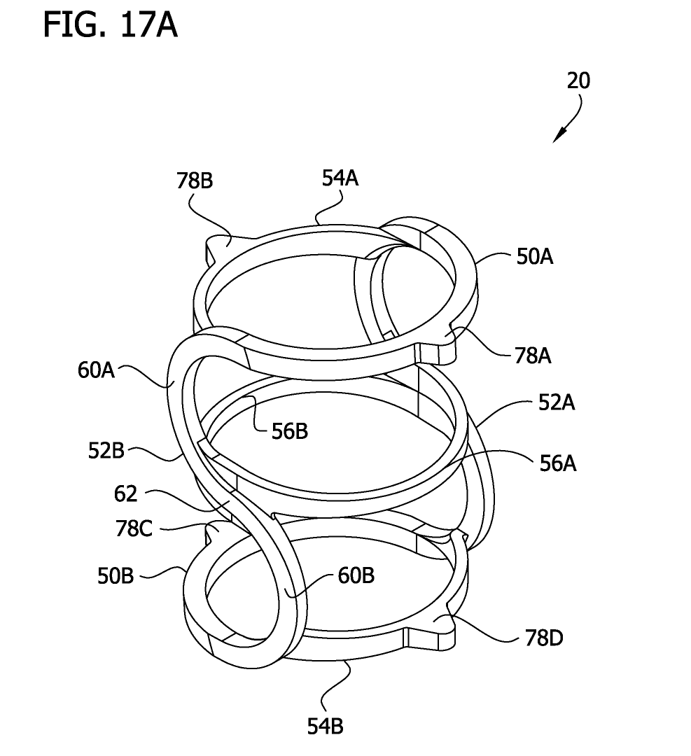

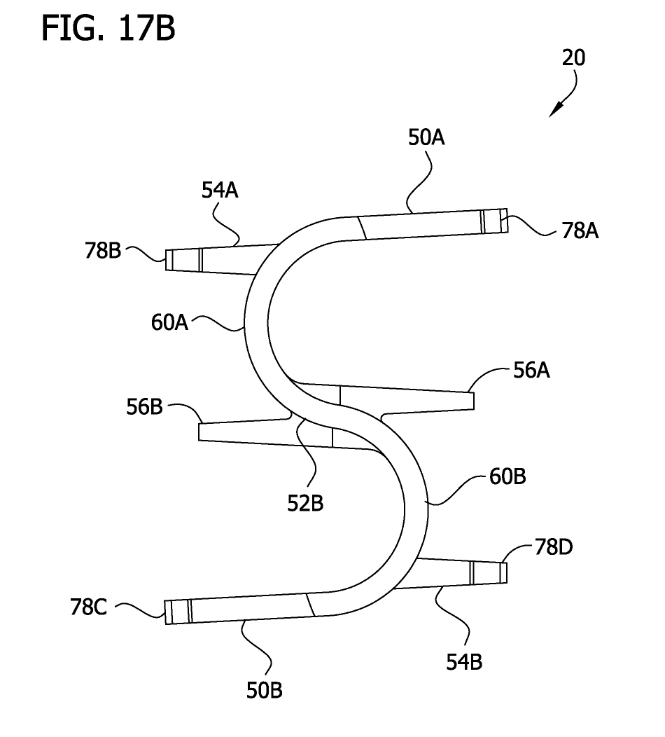

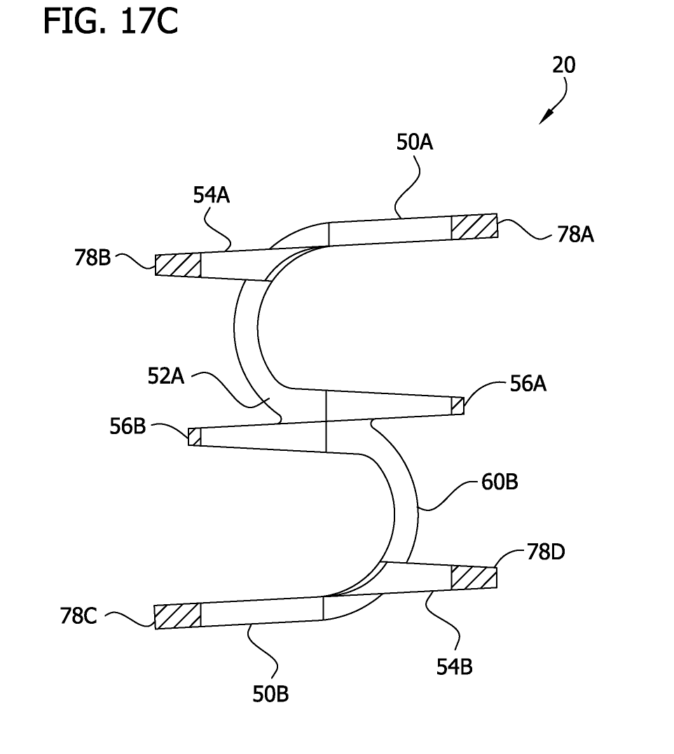

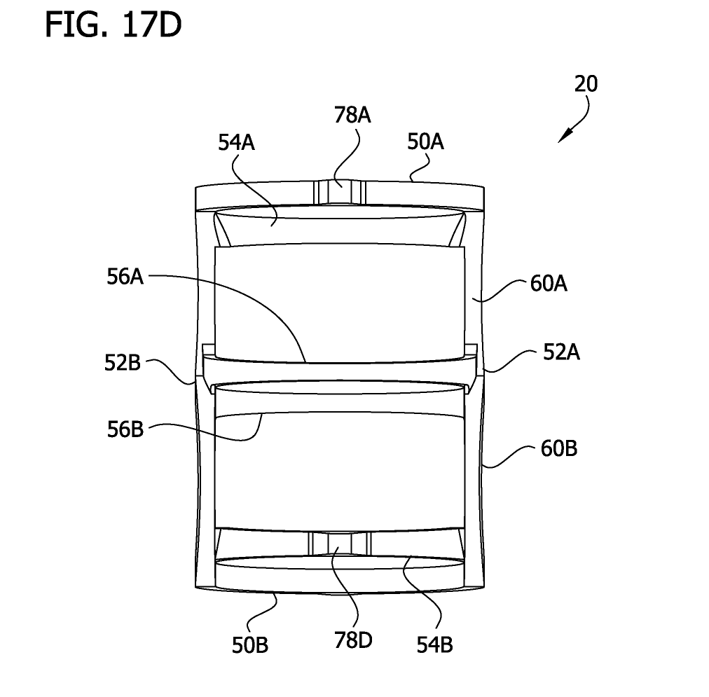

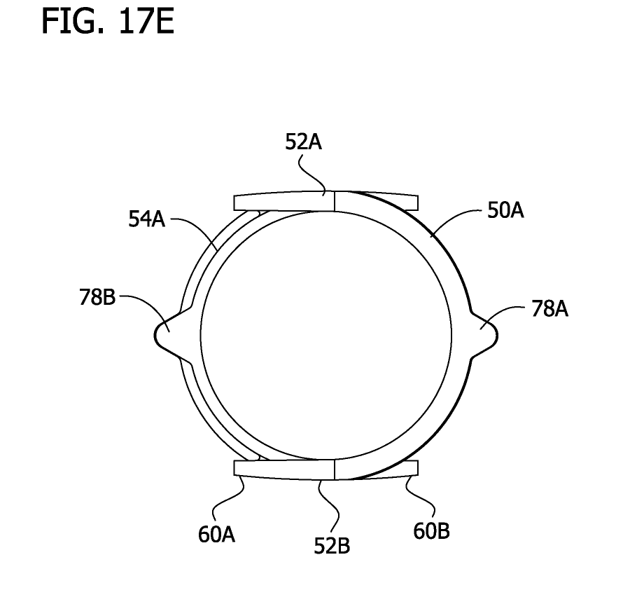

Referring now to FIGS. 17A-17E, the spring 20 is generally cylindrical. The spring includes upper and lower support members 50A, 50B, first and second spring elements 52A, 52B, upper and lower braces 54A, 54B, and upper and lower intermediate braces 56A, 56B. The upper support member 50A has an upper support surface, and the lower support member 50B has a lower support surface. The upper support surface faces upward for engaging a downward facing surface of the actuator 12, as shown in FIGS. 11, 15, and 16. The lower support surface faces downward for engaging an upward facing surface of the cap 22, as shown in FIG. 11. In the illustrated embodiment, the upper and lower support members 50A, 50B and the upper and lower support surfaces are generally U-shaped. Other spring shapes can be used without departing from the scope of the present invention. For example, the shape may be modified to further enhance the engagement of the spring 20 with the actuator 12 for conjoint rotation with the actuator or for permitting the spring to be used in other pumps.

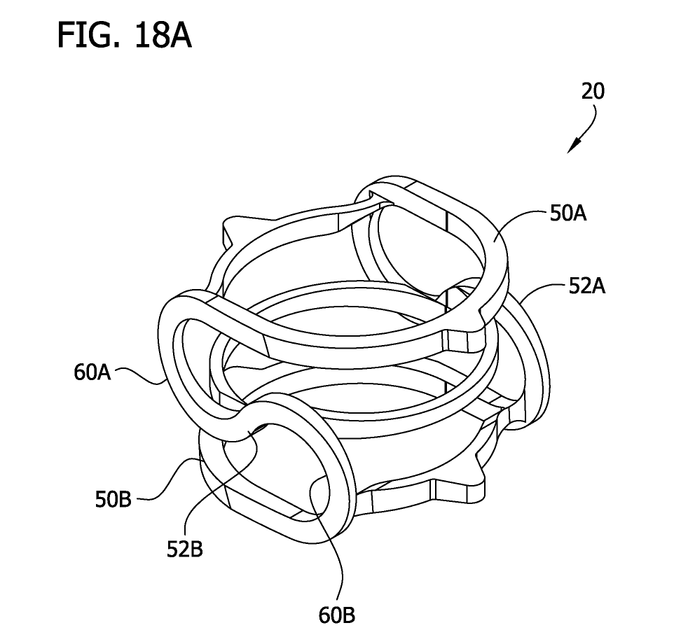

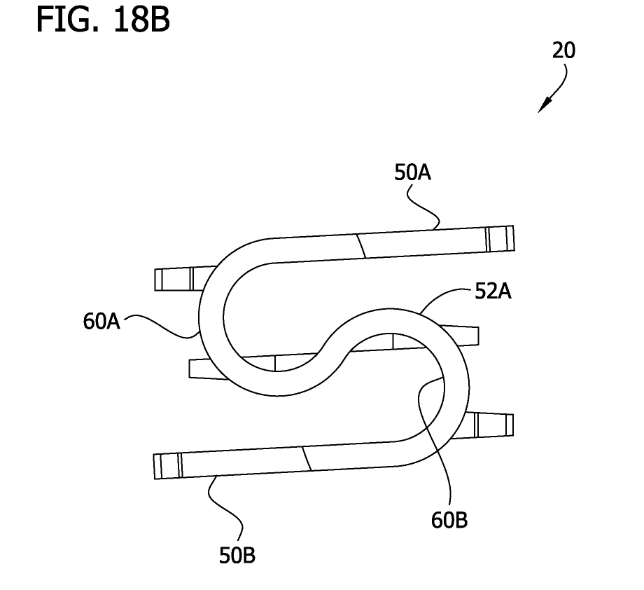

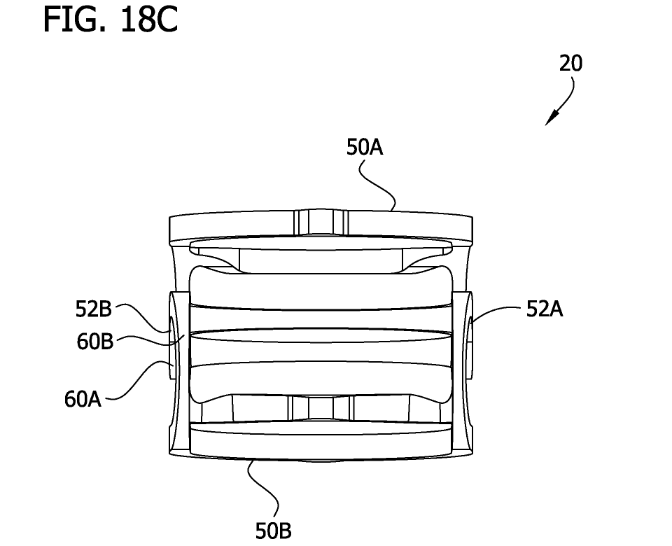

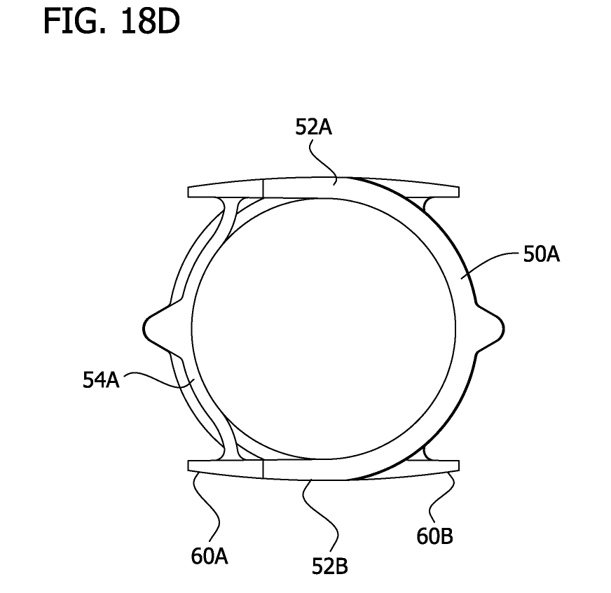

FIGS. 18A-18D illustrate various schematic views of the spring 20 in a compressed state. The spring 20 is shown schematically in the sense that it is not shown exactly as the spring of FIGS. 17A-17E would appear when compressed. The spring 20 shown in FIGS. 18A-18D includes structural differences compared to the spring shown in FIGS. 17A-17E and is provided as an example of how components of the spring might look when the spring is compressed. As will be explained in further detail below, the spring elements 52A, 52B provide maximum biasing force when compressed if they can be prevented from bulging radially outward. The spring elements 52A, 52B as shown throughout the Figures are not bulging radially outward.

Referring again to FIGS. 17A-17E, the spring elements 52A, 52B extend along the height of the spring between the upper and lower support members 50A, 50B. The spring elements 52A, 52B connect the upper and lower support members 50A, 50B to each other. The spring elements 52A, 52B are constructed to be resiliently vertically compressible to provide a force biasing the actuator 12 toward its unactuated position. The spring elements 52A, 52B include multiple segments of curvature which bend when the spring is compressed. In the illustrated embodiment, the spring elements each include first (upper) and second (lower) segments 60A, 60B of curvature. The first and second segments 60A, 60B of curvature have opposite concavity. More specifically, the first segment 60A has a concave surface which opens toward the rear of the spring, and the second segment 60B has a concave surface which opens toward the front of the spring. The segments 60A, 60B are connected to each other at a region 62 positioned generally midway along the height of the spring. In the illustrated embodiment, the segments 60A, 60B of curvature are configured to provide the spring elements 52A, 52B with a generally S-shape. The spring elements 52A, 52B may include degrees of curvature other than shown without departing from the scope of the present invention. Moreover, other numbers of segments of curvature may be used without departing from the scope of the present invention. For example, three segments of curvature may be used, which may provide the spring elements with a curved generally M-shape (not shown). Still further, the spring segments may be all straight and have shapes such as “M”, “W” and “Z” with sharper corners (not shown). Moreover, the spring may include segments which include a mixture of straight and curved sections (not shown).

In the illustrated embodiment, the spring elements 52A, 52B are provided on opposite left and right sides of the spring. More specifically, a vertical plane including the axis A-A indicated in FIG. 1 divides the spring into opposite left and right sides. The plane would extend from left to right within the page in the views shown in FIGS. 17B and 17C and out of the page in the views shown in FIGS. 17D and 17E. Substantially the entire height of each spring element 52A, 52B is positioned on the respective left or right side of the spring. In other words, the spring elements 52A, 52B do not intersect the plane which divides the spring into opposite left and right sides. Stated another way, the spring elements 52A, 52B make less than a 360 degree turn, and more particularly less than a 180 degree turn, around a circumference of the spring as they rise from the lower support member to the upper support member. Accordingly, the spring elements 52A, 52B are non-helical. The illustrated spring elements 52A, 52B are symmetrical about the plane which divides the spring into opposite left and right sides, but asymmetrical spring elements may be used without departing from the scope of the present invention.

In the illustrated embodiment, the spring elements 52A, 52B extend upward in separate, spaced and generally parallel vertical planes. The planes would extend from left to right within the page in the views shown in FIGS. 17B and 17C and out of the page in the views shown in FIGS. 17D and 17E. The spring elements 52A, 52B having such a vertical orientation provides the spring 20 with a leaf-spring type loading when compressed. The spring elements 52A, 52B each include an outer engagement surface extending along the height of the spring elements which may interface with the actuator 12, as explained further below. As shown in FIG. 17E, the outer engagement surfaces are minimally curved around the circumference of the spring. The engagement surfaces may be substantially flat. Such minimal curvature or substantial flatness may be referred to as “generally flat.” The engagement surfaces may have other shapes or profiles (e.g., more dramatic curvature) without departing from the scope of the present invention.

The braces 54A, 54B, 56A, 56B extend along the width of the spring between the first and second spring elements 52A, 52B. The braces connect the first and second spring elements 52A, 52B to each other to prevent the spring elements from bulging radially outward when the spring 20 is compressed. Such radial bulging might decrease the biasing force which the spring is capable of exerting on the actuator. The illustrated braces 54A, 54B, 56A, 56B are substantially horizontal. In other words, the braces extend generally perpendicular to the vertical axis of the spring. As illustrated in FIGS. 17B-17D, the braces 54A, 54B, 56A, 56B are positioned on the spring relative to the upper and lower support members 50A, 50B such that the braces are below the upper support member and above the lower support member. More specifically, the upper brace 54A is positioned immediately below the upper support member 50A, and the lower brace 54B is positioned immediately above the lower support member 50B. The upper intermediate brace 56A is positioned immediately above the vertical midpoint (i.e., regions 62) of the spring elements 52A, 52B, and the lower intermediate brace 56B is positioned immediately below the vertical midpoint of the spring elements. The braces 54A, 54B, 56A, 56B extend in horizontal planes which are generally parallel to and inboard heightwise from the horizontal planes in which the upper and lower support members 50A, 50B extend. It may be desirable to provide the upper and lower braces 54A, 54B as close to the respective vertical positions of the upper and lower support members 50A, 50B as possible. The upper and lower braces 54A, 54B of this embodiment are offset vertically with respect to the support members 50A, 50B (and the upper and lower intermediate braces 56A, 56B are vertically offset with respect to each other) so the spring may be formed in one close-and-open injection molding process. Braces having other configurations may be used without departing from the scope of the present invention. Moreover, in some embodiments, additional braces may be provided or braces may be omitted without departing from the scope of the present invention.

The spring housing, and more particularly the actuator 12, includes engagement structure configured for engaging the outer engagement surfaces of the spring elements to assist in preventing the spring elements from bulging radially outward when the spring is compressed. As mentioned above, such radial bulging might decrease the biasing force the spring 20 is capable of providing against the actuator 12. Referring to FIGS. 5, 13, 14, and 16, the actuator 12 includes opposite left and right inner walls 70A, 70B positioned for engaging the outer engagement surfaces of the spring elements 52A, 52B. In the illustrated embodiment, the inner walls 70A, 70B are generally flat to generally correspond to the generally flat left and right engagement surfaces of the spring elements 52A, 52B for engaging the outer engagement surfaces of the spring elements in generally flatwise engagement. The engagement structure may be modified to include curved walls (not shown) for more closely conforming to the minimally curved spring element engagement surfaces without departing from the scope of the present invention. As illustrated in FIG. 16, as the actuator 12 is moved downward toward the actuated position, the left and right inner walls 70A, 70B move downward along the outer engagement surfaces of the compressing spring elements 52A, 52B to a vertical position about mid-height of the spring elements (i.e., adjacent the regions 62 of the spring elements). Accordingly, the inner walls 70A, 70B engage and prevent the spring elements 52A, 52B from bulging outward away from the vertical axis of the spring 20.

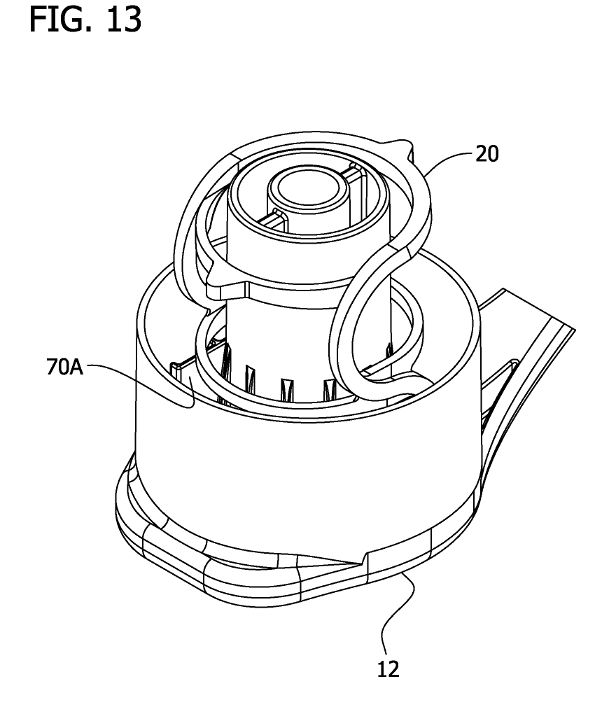

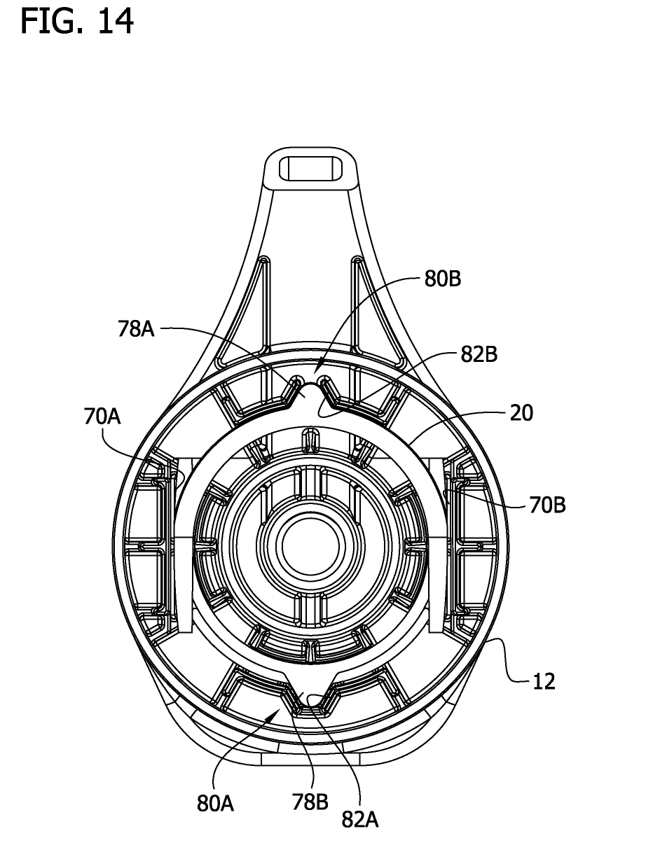

Referring to FIG. 17A, the spring 20 includes mating structure in the form of protrusions 78A, 78B provided on the upper support member 50A and upper brace 54A and protrusions 78C, 78D provided on the lower support member 50B and lower brace 54B. In the illustrated embodiment, the protrusions 78A-78D have a generally rounded triangle profile, with the apex of the triangle facing away from the respective supports and braces. The mating structure on the spring 20 is provided for forming mating connections, generally indicated by 80A, 80B (FIGS. 11 and 14), with mating structure on the actuator. As shown in FIGS. 11 and 14, the mating structure on the actuator includes recesses 82A, 82B positioned for receiving respective protrusions 78A, 78B when the spring 20 is operatively engaged with the actuator 12. FIG. 13 is a bottom perspective of the spring 20 engaged with the actuator 12. The protrusions 78A-78D are provided on the upper and lower ends of the spring so the spring can form mating connections with the actuator 12 regardless of whether the upper or lower end of the spring is engaged with the actuator. FIG. 14 is a bottom view of the spring 20 and actuator 12 of FIG. 13. As shown, the reception of the protrusions 78A, 78B in the recesses 82A, 82B form the mating connections 80A, 80B which cause the spring 20 to rotate conjointly with the actuator 12 about the vertical axis of the pump 10 when the actuator is moved between the on and off positions. The mating structure at the lower end of the spring 20 does not mate with the cap 22 so the spring rotates independently from the cap. Accordingly, the mating connections 80A, 80B assist in maintaining the outer engagement surfaces of the spring elements 52A, 52B in register with the inner walls 70A, 70B of the actuator 12 for promoting maximum assistance of the inner walls in preventing the spring elements from bulging radially outward when compressed. Other types of mating connections may be used or the mating connections may be omitted without departing from the scope of the present invention. For example, the protrusions 78A-78D may have other configurations or shapes without departing from the scope of the present invention.

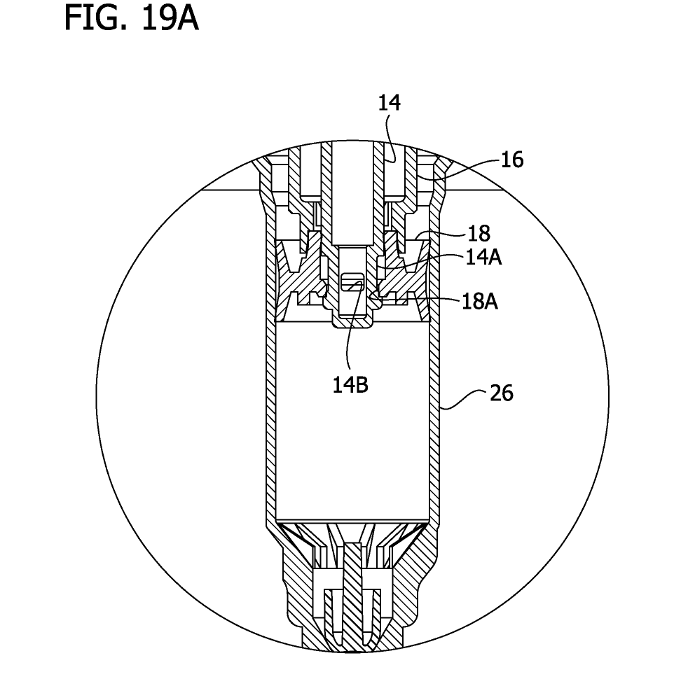

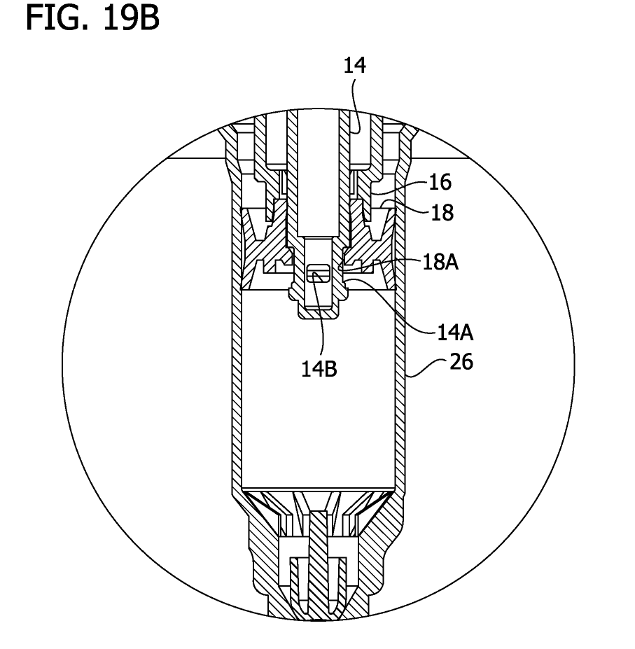

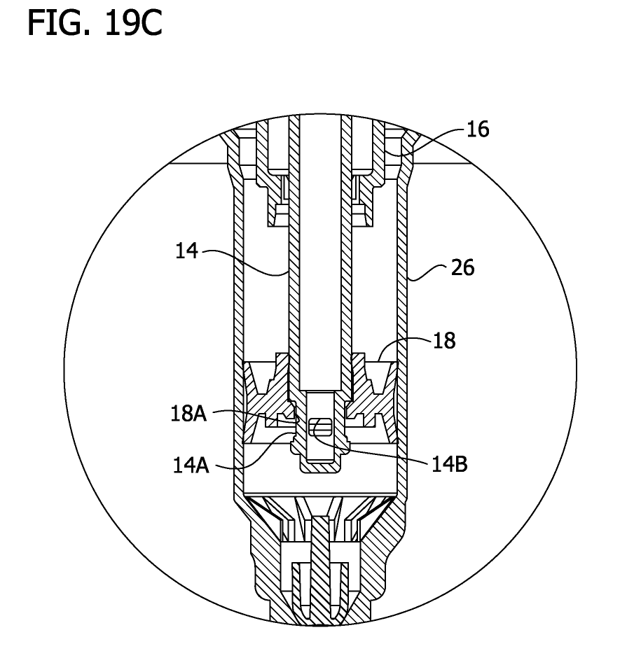

FIGS. 19A-19B illustrate a shifting seal or lost motion connection of the piston shaft 14 with the piston member 18. The piston shaft 14 is connected to the piston member 18 by reception of the piston shaft through a central opening in the piston member. The connection of the piston shaft 14 and piston member 18 acts as a valve to prevent fluid from flowing from the housing 26 into the piston shaft 14 when the pump 10 is not in the actuated position. Moreover, the shifting seal or lost motion connection assists in compensating for reduction of length of the compression spring 20 as the spring undergoes repeated compression cycles over time.

As shown in FIG. 19A, the piston shaft 14 includes a circumferential recess 14A which receives an inner circumferential shoulder 18A of the piston member 18. The piston shaft 14 has a reduced external diameter at the circumferential recess 14A. The circumferential shoulder 18A of the piston member 18 has an inner diameter which is about the same as the outer diameter of the circumferential recess 14A. The circumferential recess 14A has an external diameter and a length extending along the length of the piston shaft 14 which are sized to permit the shoulder 18A of the piston member to slide along the piston shaft 14 within the circumferential recess 14A between lower and upper ends of the circumferential recess. The piston shaft 14 has inlet openings 14B spaced around the circumference of the piston shaft adjacent the shifting seal or lost motion connection (e.g., within the circumferential recess 14A). The piston member 18 blocks fluid from flowing from the housing 26 through the inlet openings 14B when the shoulder 18A of the piston member 18 is below the inlet openings 14B. The piston member 18 permits flow of fluid from the housing 26 through the inlet openings 14B when the shoulder 18A of the piston member is above the inlet openings.

As shown in FIG. 19A, when the pump 10 is in an unactuated position, the piston member 20 is in a lowered position relative to the piston shaft 14. The piston member 18 is seated in a lower end of the chaplet 16. The compression spring 20 biases the actuator 12 away from the housing 26, and the piston shaft 14 is connected to the actuator such that the spring maintains the piston shaft in a raised (unactuated) position within the housing such as illustrated in FIG. 19A. In the raised position, the piston member 18 acts as a valve for preventing fluid from flowing from the housing 26 into the inlet openings 14B. The shoulder 18A of the piston member 18 is below the inlet openings 14B of the piston shaft 14 and thus blocks flow of fluid from entering the piston shaft through the inlet openings.

An actuation of the actuator 12 generally includes a downward stroke and an upward stroke. The downward stroke is caused by the user forcing the actuator downward against the bias of the spring from the unactuated position to the actuated position. The upward stroke is caused by the spring forcing the actuator upward to the unactuated position. As shown in FIG. 19B, when a user begins the downward stroke by overcoming the bias of the spring 20, initially the piston shaft 14 but not the piston member 18 moves downward within the housing 26. The reduced external diameter of the circumferential recess 14A of the piston shaft 14 permits the piston shaft to slide downward through the central opening of the piston member 18. When the upper end of the circumferential recess 14A reaches the shoulder 18A of the piston member 18, the piston member begins to move downward in the housing 26, forcing fluid from in the housing through the inlet openings 14B. For example, the circumferential recess 14A may have a length of about 0.079 inches (2.0 mm) such that the piston shaft 14 moves downward about that length before positively engaging the piston member 18. The connection is referred to as a shifting seal connection because the engagement of the piston shaft 14 with the piston member 18 creates a seal to prevent fluid from passing between the circumferential recess 14A and the piston member shoulder 18A but permits the piston shaft to move with respect to the piston member 18. As shown by comparison of FIGS. 19A and 19B, the seal formed adjacent the piston member shoulder 18A “shifts” from below the piston shaft inlet openings 14B to above the openings as the actuator 12 is moved downward to permit flow through the inlet openings from the housing 26. For example, the actuator 12 may be moved to dispense fluid such that the piston member 18 is pushed downward at the bottom of the downward stroke to a position such as shown in FIG. 19C.

When the user releases pressure on the actuator 12, the bias of the compression spring 20 causes the actuator 12 and the piston shaft 14 to move upward in the upward stroke. The piston member 18 moves upward together with the piston shaft 14. Near the upper portion of the upper stroke, the piston member 18 seats in the bottom of the chaplet 16 and thus stops moving upward, as shown in FIG. 19B. The spring 20 continues to move the piston shaft 14 upward. As the piston shaft 14 moves upward relative to the piston member 18, the seal between the piston member and the piston shaft shifts to below the inlet openings 14B, thus blocking flow through the inlet openings. The spring 20 continues to move the piston shaft 14 upward until the shoulder 18A of the piston member 18 engages the bottom of the circumferential recess 14A in the piston shaft, as shown in FIG. 19A. The pump 20 is then ready for a subsequent downward stroke to dispense additional fluid.

The shifting seal or lost motion connection between the piston shaft 14 and piston member 18 assists in compensating for reduction of length of the spring 20 which may occur over time (i.e., after numerous actuations of the actuator 12). For example, if the spring 20 is made of a plastic material, it may become less resilient or reduce in length after numerous compression cycles. To an extent, even if the spring 20 loses strength to move the piston shaft to its fully unactuated position (e.g., FIG. 19A), the spring may still be able to move the piston member 18 to its fully unactuated position (e.g., seated in the bottom of the chaplet 16 as shown in FIGS. 19A and 19B). Thus, even if the spring 20 loses resiliency or length, to an extent the spring will still move the piston member 18 sufficiently upward on the upward stroke so on the downward stroke the piston member will displace the desired amount of fluid. For example, when the spring 20 shortens, the unactuated position of the pump may be as shown in FIG. 19B. When the spring 20 shortens, the valve function of the shifting seal connection may be compromised because the spring is not strong enough to sufficiently raise the piston shaft to shift the seal between the shaft and the piston member above the inlet openings 14B. However, as long as the spring 20 is strong enough to raise the piston member 18 into its seated position in the bottom of the chaplet 16, as shown in FIG. 19B, the piston will dispense the desired amount of fluid in the downward stroke. Accordingly, the shifting seal provides compensation for reduction of length of the spring 20. It will be appreciated that the shifting seal connection could be modified (e.g., by increasing the length of the circumferential recess 14A and appropriately positioning the inlet openings 14B) such that the connection can compensate for reduction of spring length while still maintaining the valve function of the connection.

The pump 10 may be designed to have an output which is slightly more than the desired output to compensate for reduction of length of the compression spring 20 over time. For example, the pump 10 may be designed to have an output (e.g., about 1.78 cc) which is about 20 percent higher than the desired output (e.g., about 1.5 cc). If the compression spring 20 is made of a material such as plastic, the spring may decrease in length after numerous compression cycles. As a result, the stroke length of the piston shaft 14 and the piston member 18 may be reduced. In other words, because the spring 20 does not raise the piston member 18 as high in the housing 26 as when the spring was new, not as much fluid will be moved through the pump 10 in a full stroke of the actuator 12. Such reduction in length of the spring 20 may be anticipated and accounted for by providing the pump 10 with a greater initial output.

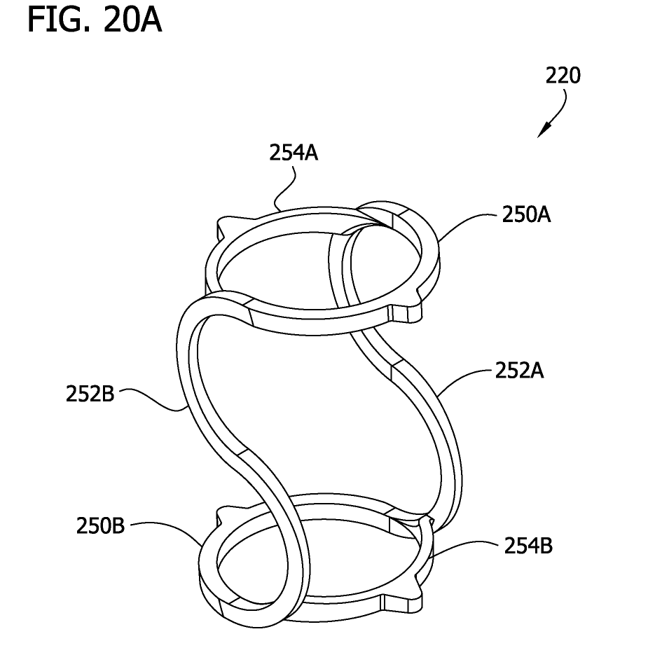

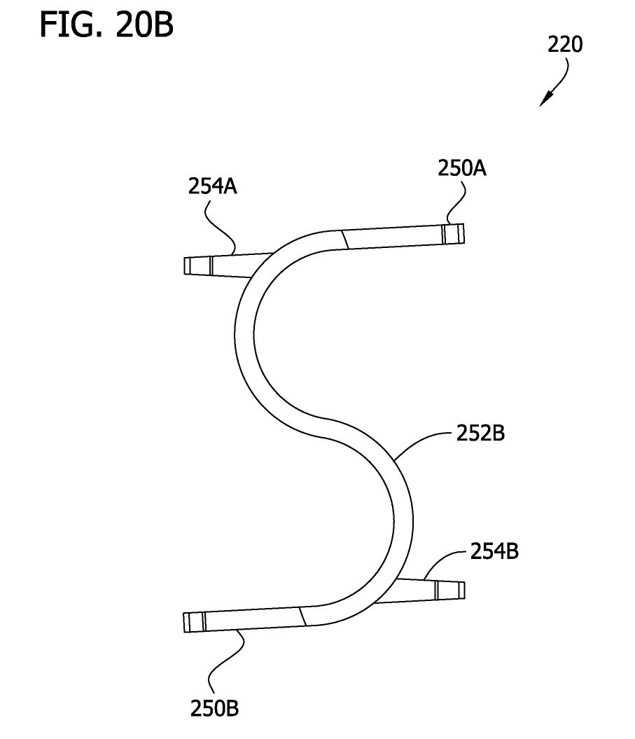

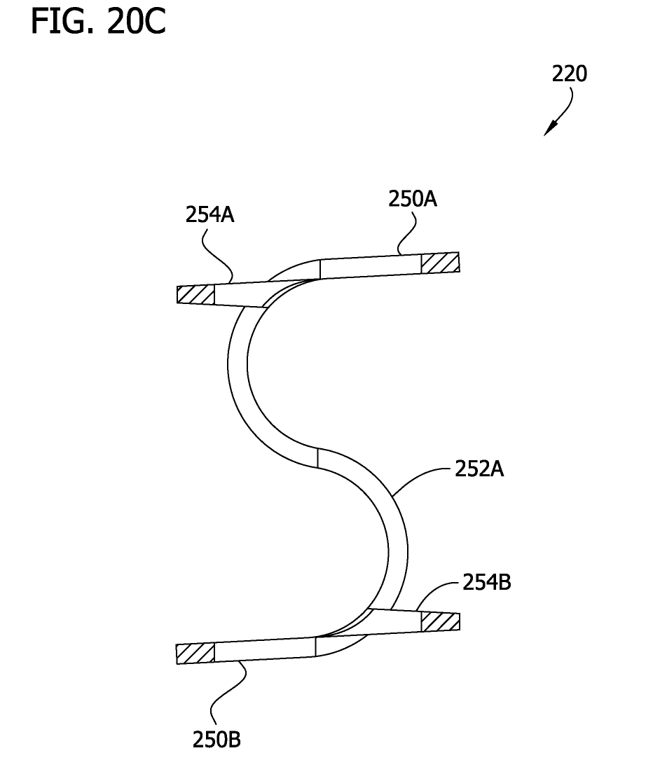

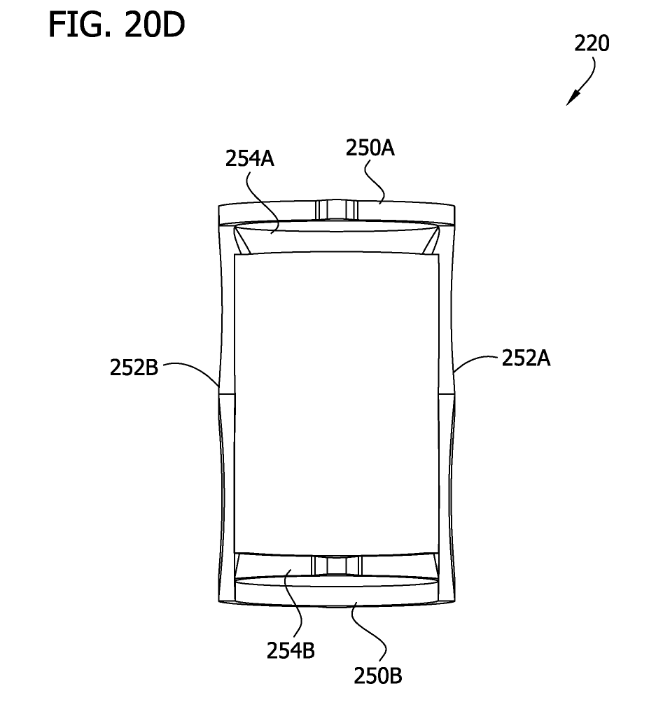

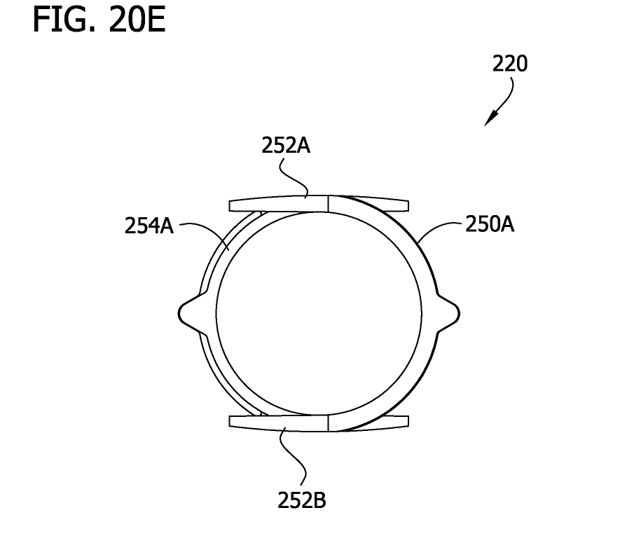

FIGS. 20-29 illustrate additional embodiments of springs of the present invention. Although the springs are not illustrated as part of a pump, it will be understood the springs may be combined with the pump components illustrated in FIGS. 1-16 (or suitably modified pump components) for forming a pump according to the present invention.

FIGS. 20A-20E illustrate various views of a second embodiment of a spring 220 of the present invention. The spring is similar to the spring described above, and corresponding reference numbers are provided, plus 200. For example, the spring is generally cylindrical and includes upper and lower connecting or support members 250A, 250B, spring elements 252A, 252B extending between the support members, and upper and lower braces 254A, 254B (broadly “connecting members”) extending between the spring elements. In this embodiment, the upper and lower intermediate braces are omitted.

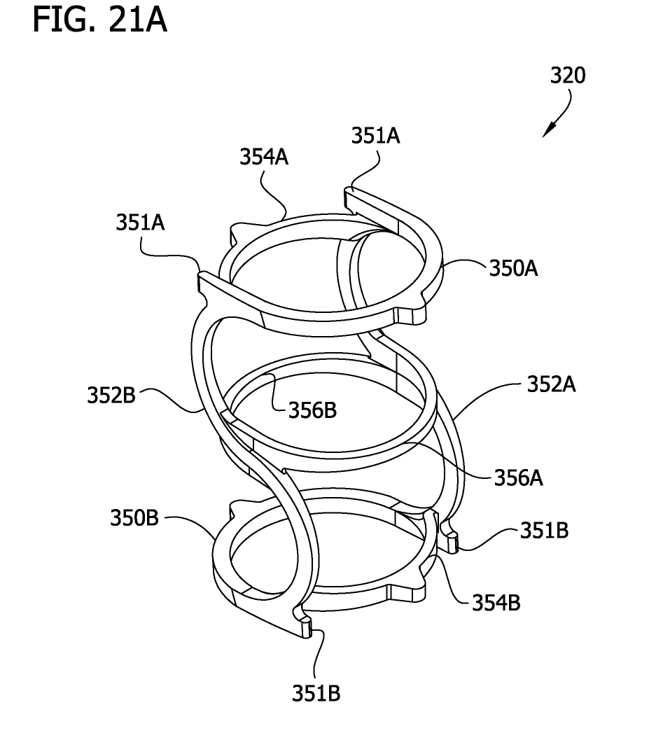

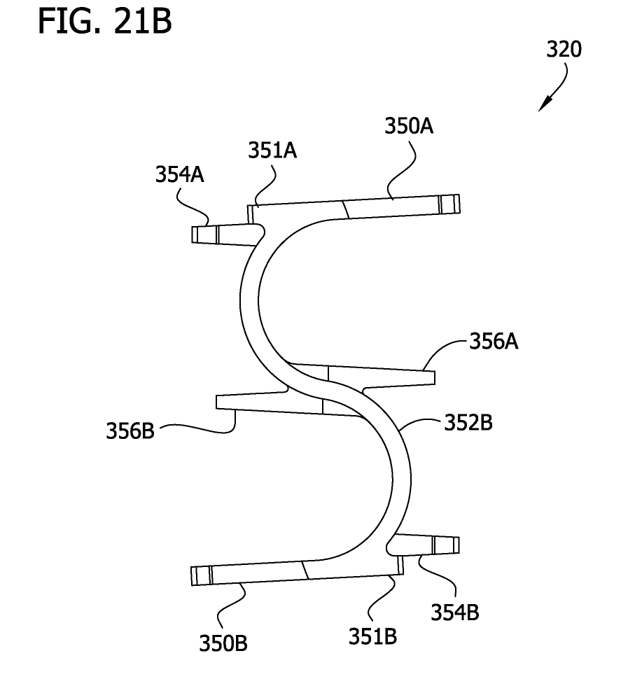

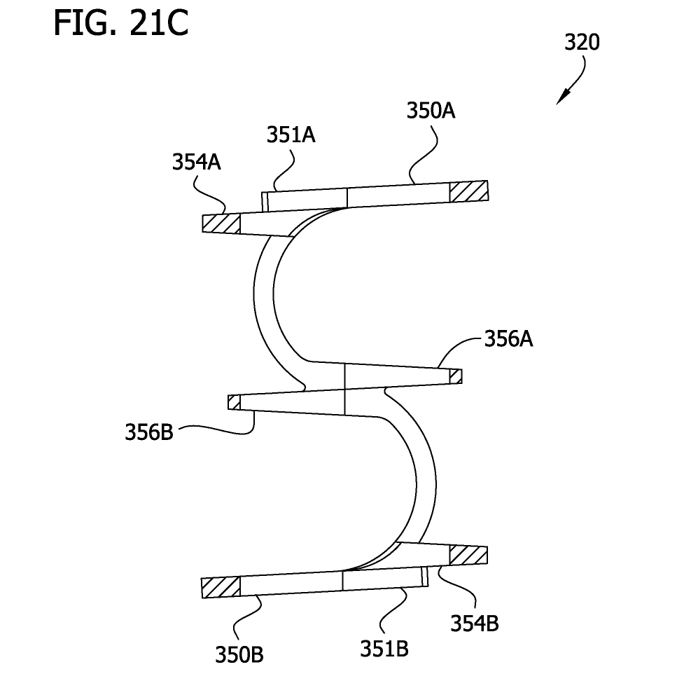

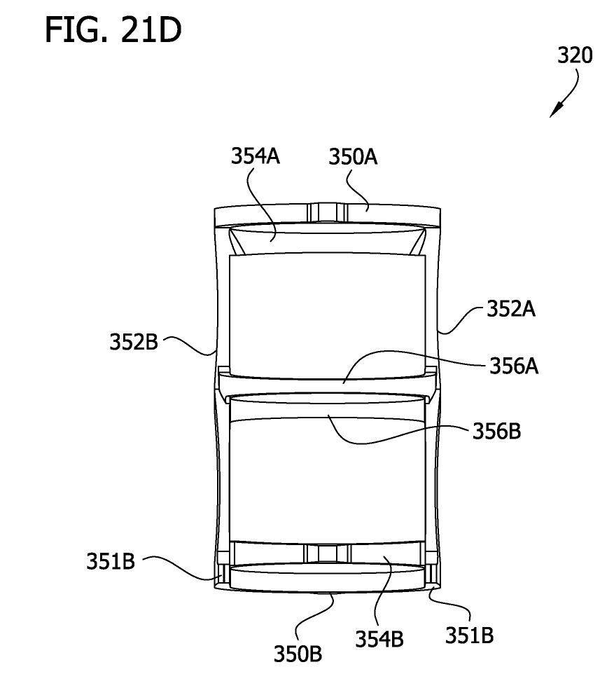

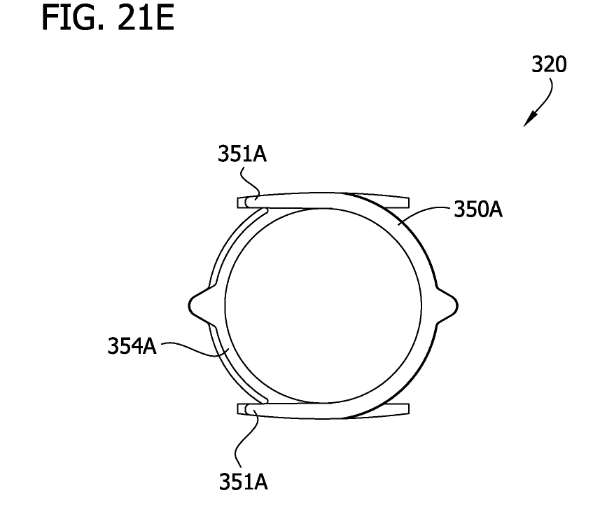

FIGS. 21A-21E illustrate various views of a third embodiment of a spring 320 of the present invention. The spring is similar to the spring 20 described above, and corresponding reference numbers are provided, plus 300. For example, the spring is generally cylindrical and includes upper and lower support members 350A, 350B, spring elements 352A, 352B extending between the support members, upper and lower braces 354A, 354B, and upper and lower intermediate braces 356A, 356B. In this embodiment, the upper and lower support members 350A, 350B include feet 351A, 351B which provide the generally U-shapes of the support members and the bearing surfaces with extended bearing surfaces. In other words, the bearing surfaces are extended to assist in preventing the spring 320 from tipping forward or rearward inside the pump housing.

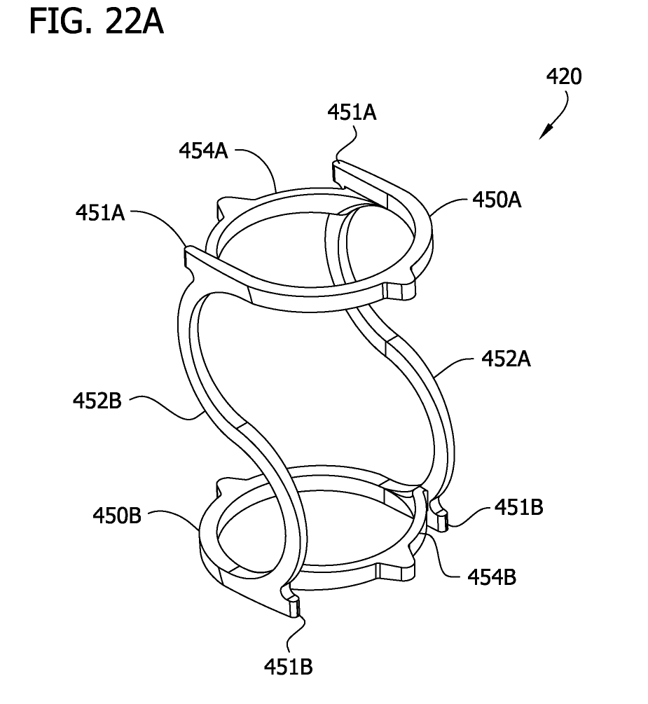

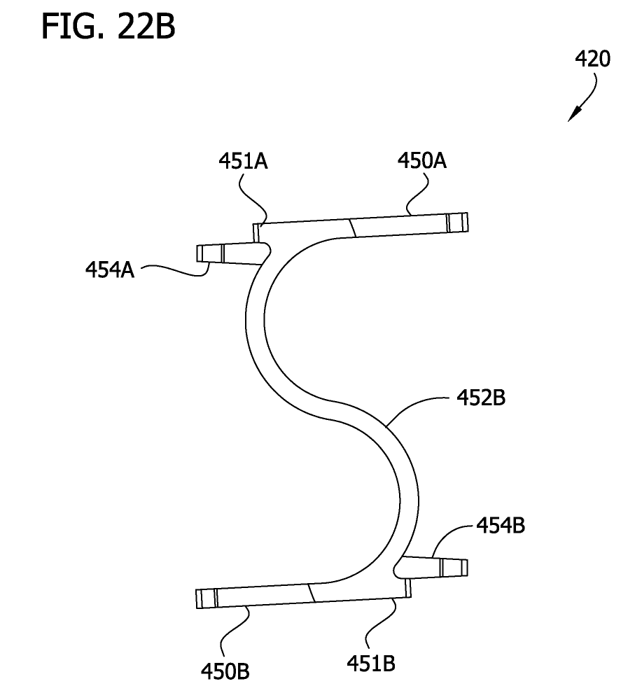

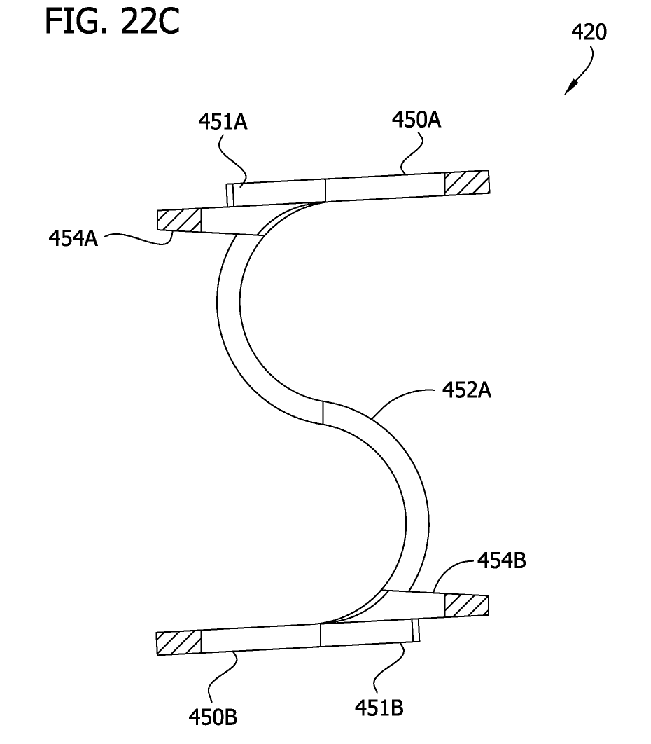

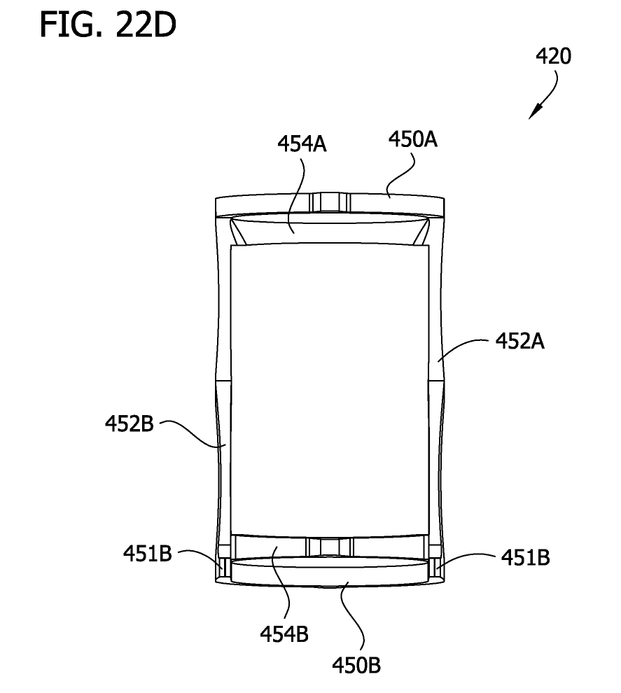

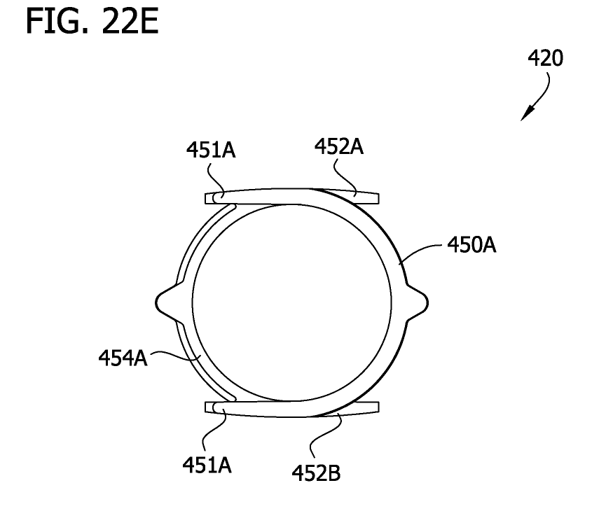

FIGS. 22A-22E illustrate various views of a fourth embodiment of a spring 420 of the present invention. The spring is similar to the spring 320 described above, and corresponding reference numbers are provided, plus 100. For example, the spring is generally cylindrical and includes upper and lower support members 450A, 450B, spring elements 452A, 452B, upper and lower braces 454A, 454B, and feet 451A, 451B. In this embodiment, the upper and lower intermediate braces are omitted.

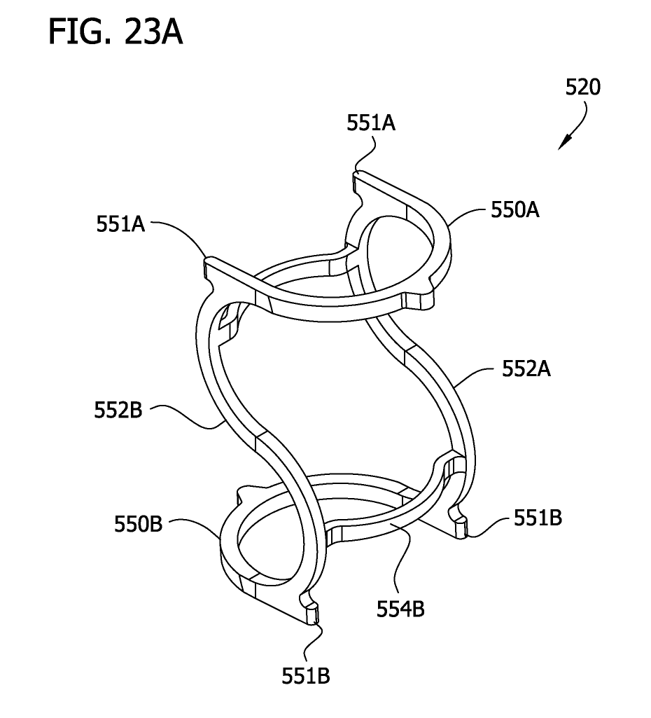

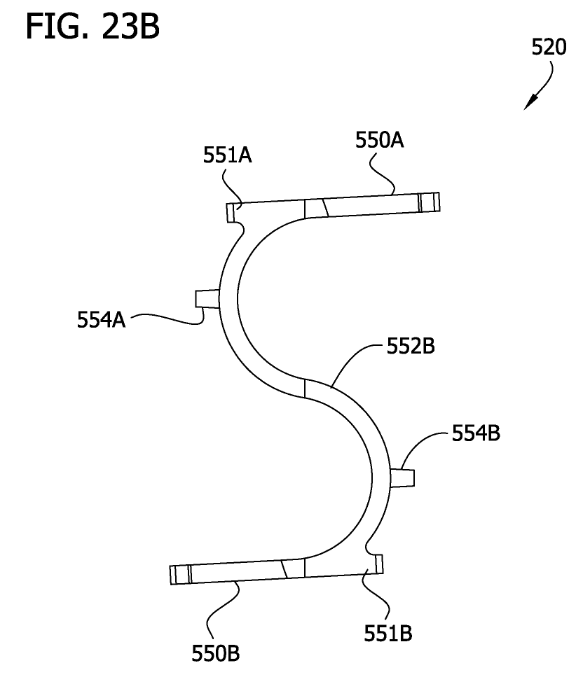

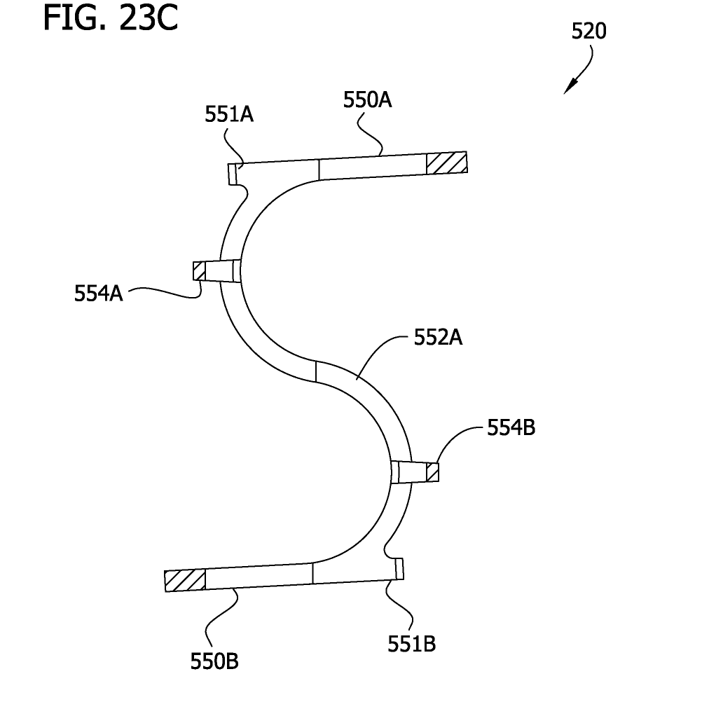

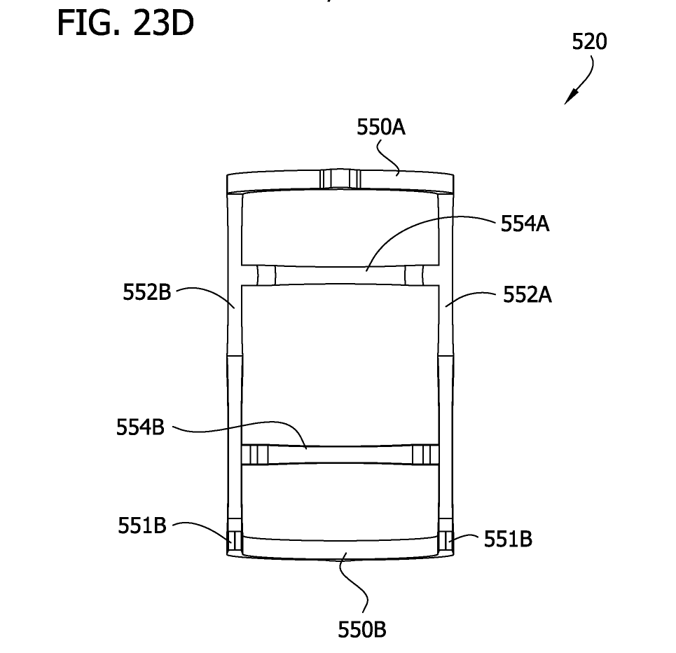

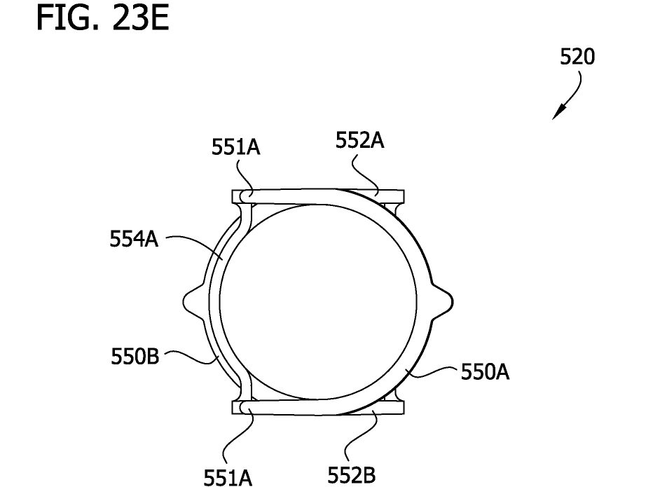

FIGS. 23A-23E illustrate various views of a fifth embodiment of a spring 520 of the present invention. The spring is similar to the spring 420 described above, and corresponding reference numbers are provided, plus 100. For example, the spring is generally cylindrical and includes upper and lower support members 550A, 550B, spring elements 552A, 552B, upper and lower braces 554A, 554B, and feet 551A, 551B. In this embodiment, a greater vertical offset or spacing is provided between the upper and lower support members 550A, 550B and respective upper and lower braces 554A, 554B. Moreover, the protrusions on the upper and lower braces 554A, 554B are omitted.

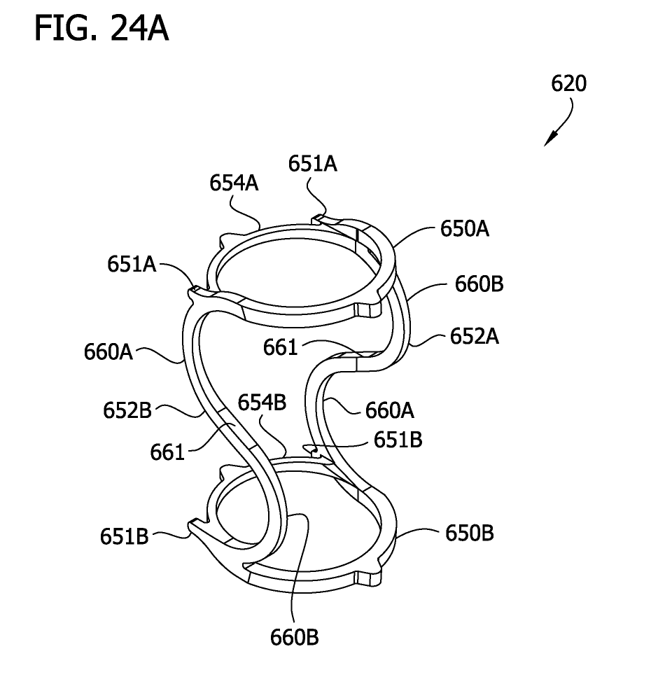

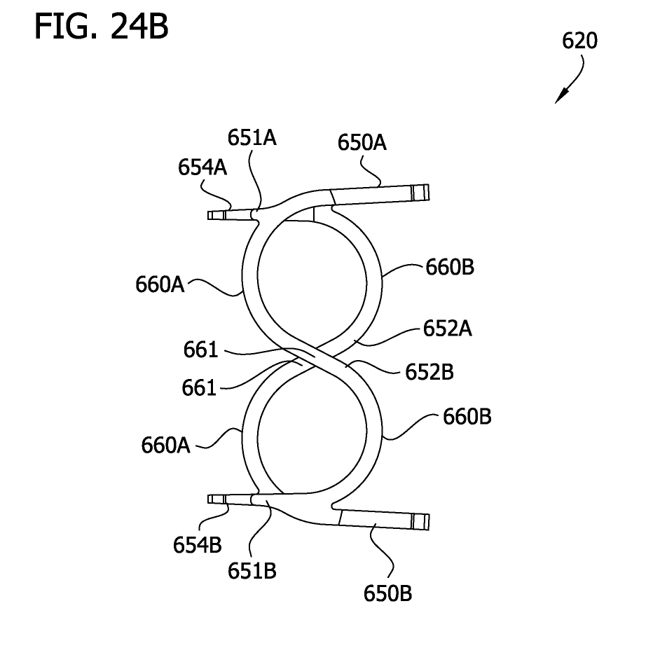

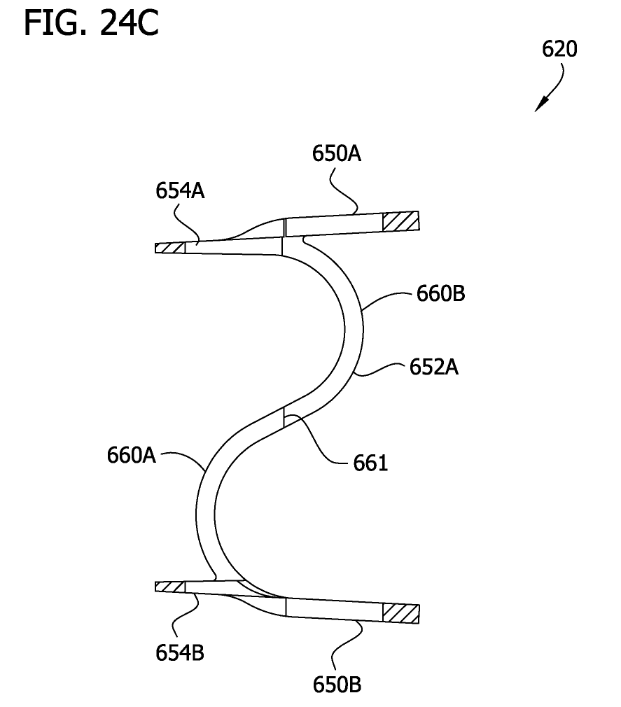

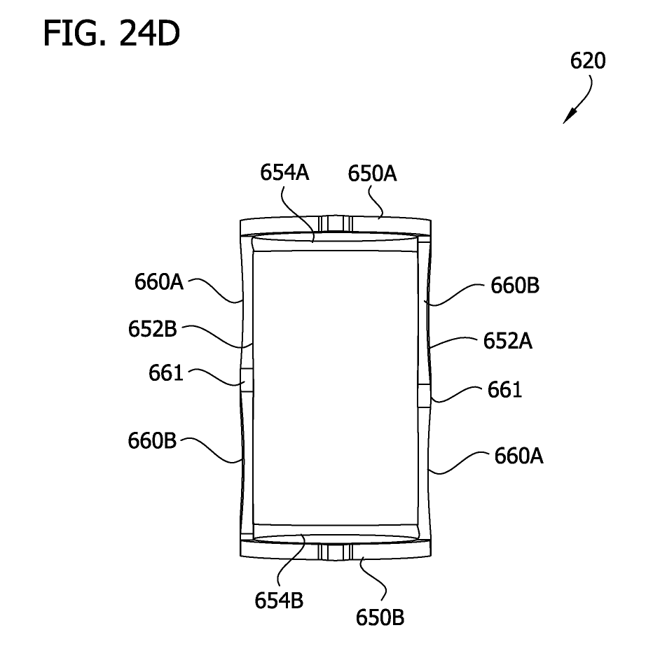

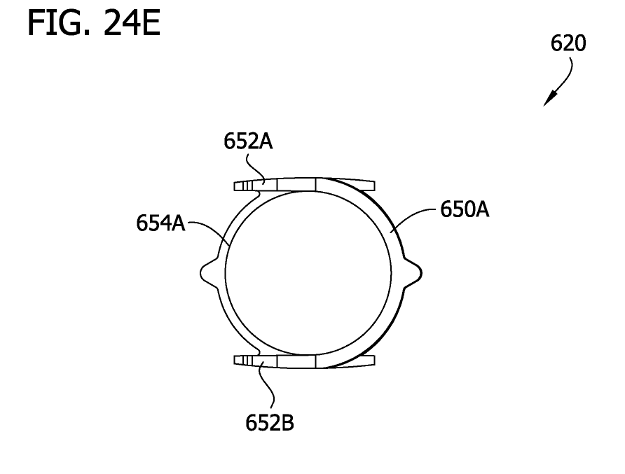

FIGS. 24A-24E illustrate various views of a sixth embodiment of a spring 620 of the present invention. The spring is similar to the spring 420 described above, and corresponding reference numbers are provided, plus 200. For example, the spring is generally cylindrical and includes upper and lower support members 650A, 650B, spring elements 652A, 652B, upper and lower braces 654A, 654B, and feet 651A, 651B. In this embodiment, the spring elements 652A, 652B are positioned in opposite orientations on the left and right sides of the spring, instead of being positioned symmetrically with respect to the plane which divides the spring into the left and right sides. As shown in FIG. 24B, the spring elements 652A, 652B form a FIG. 8 shape when viewed from the side. It is believed such an asymmetrical orientation of the spring elements 652A, 652B may provide greater biasing force when the spring 620 is compressed because the opposite orientations cause torsion to be applied to the spring elements when loaded. In addition, in this embodiment, the spring elements 652A, 652B have a different side profile compared to prior embodiments. More specifically, as shown in FIG. 24B, the segments 660A, 660B of curvature are curved more sharply, the first and second segments 660A, 660B of curvature are curved to different degrees with respect to each other, and a generally straight portion 661 is provided between the segments of curvature. Moreover, in this embodiment, the feet 651A, 651B are offset slightly inboard heightwise with respect to the upper and lower support members 650A, 650B.

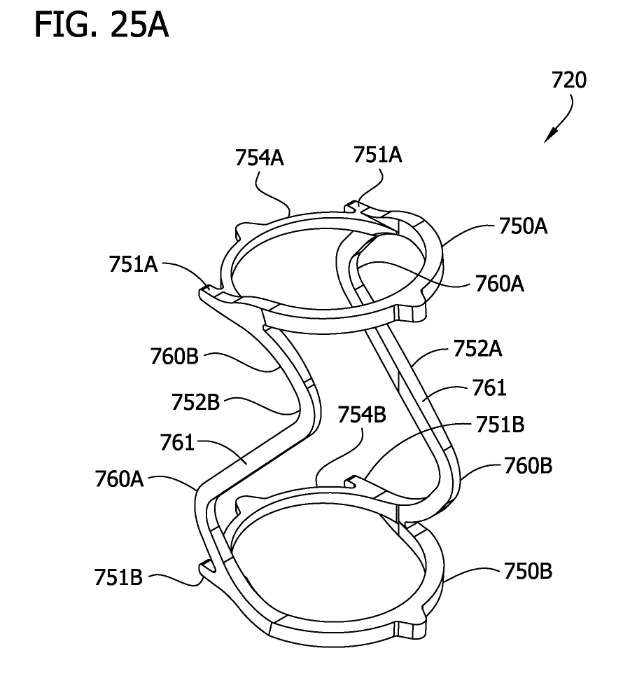

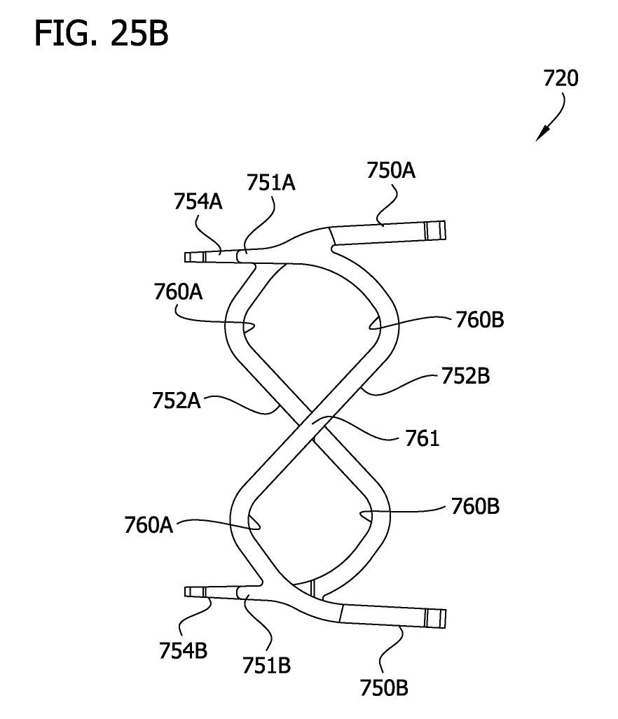

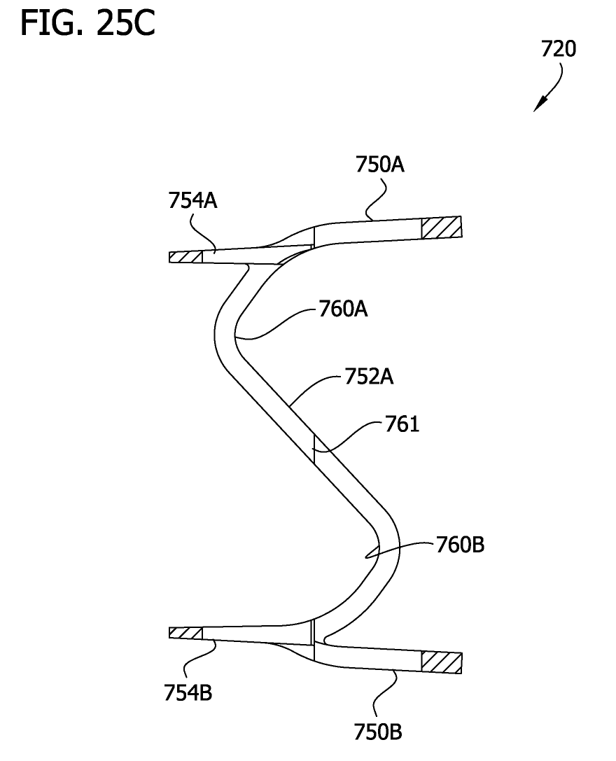

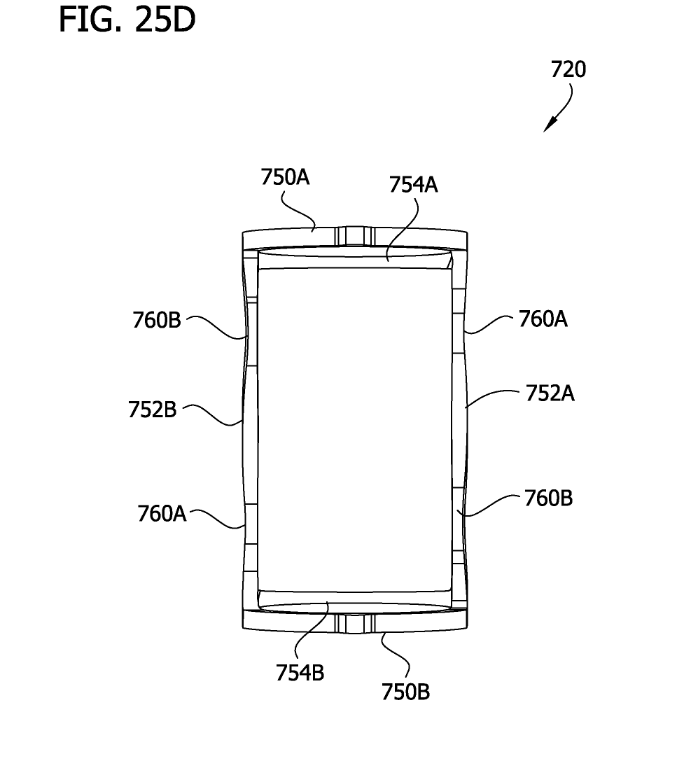

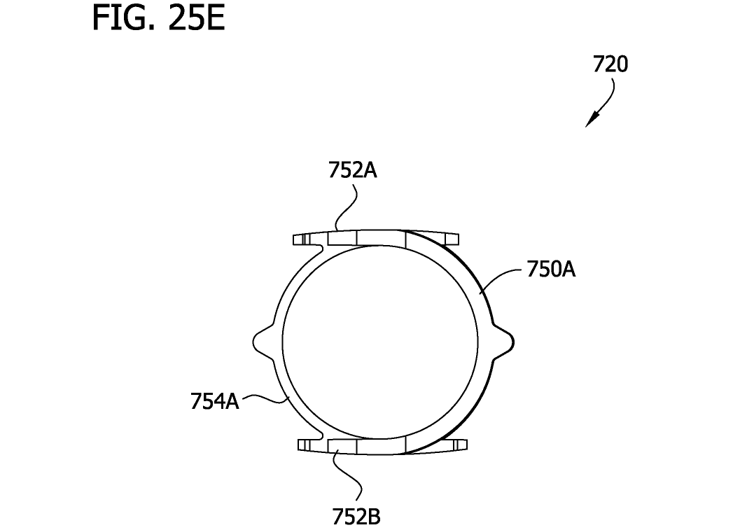

FIGS. 25A-25E illustrate various views of a seventh embodiment of a spring 720 of the present invention. The spring is similar to the spring 620 described above, and corresponding reference numbers are provided, plus 100. For example, the spring is generally cylindrical and includes upper and lower support members 750A, 750B, spring elements 752A, 752B, upper and lower braces 754A, 754B, and feet 751A, 751B. In this embodiment, the spring elements 752A, 752B have a different side profile compared to prior embodiments. The spring elements 752A, 752B are similar to the spring elements 652A, 652B in that the spring elements are provided in opposite orientations and the first and second segments 760A, 760B of curvature of each spring element are curved to different degrees with respect to each other. In this embodiment, the segments 760A, 760B of curvature are curved more sharply, and the generally straight portion 761 between the segments of curvature is longer.

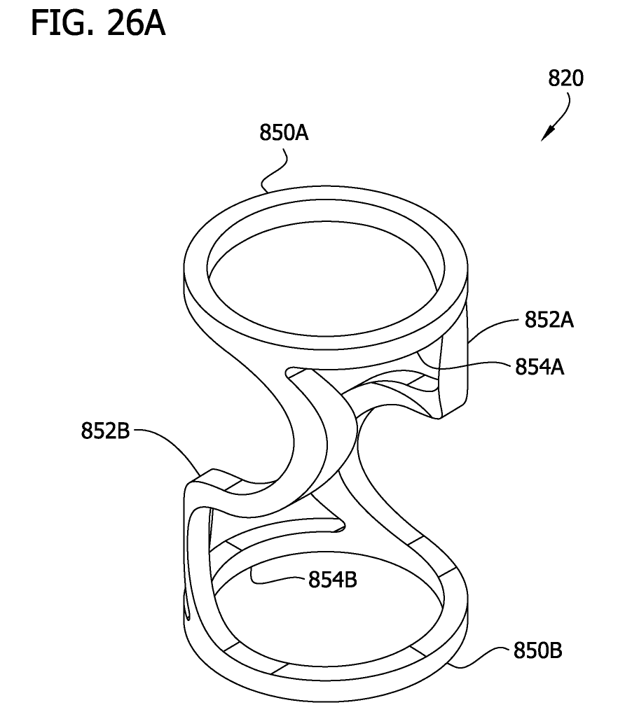

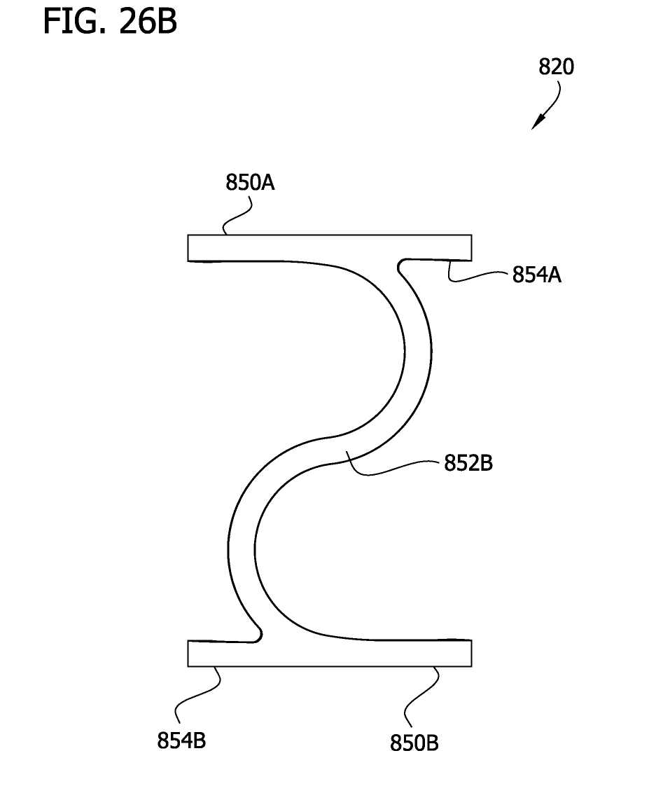

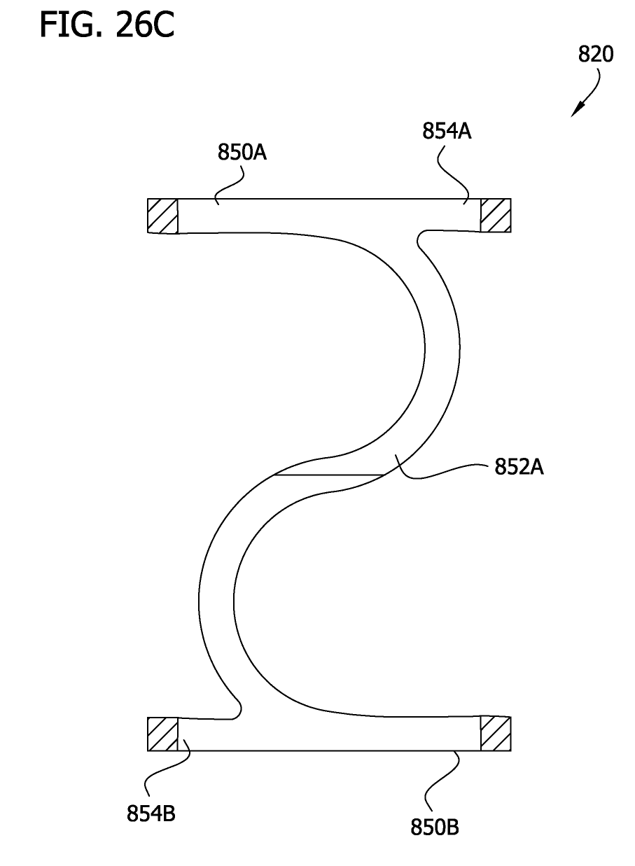

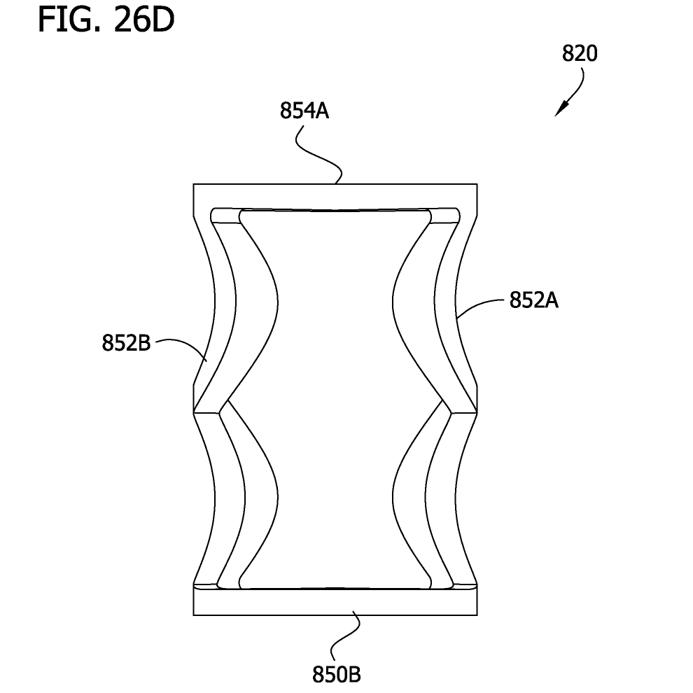

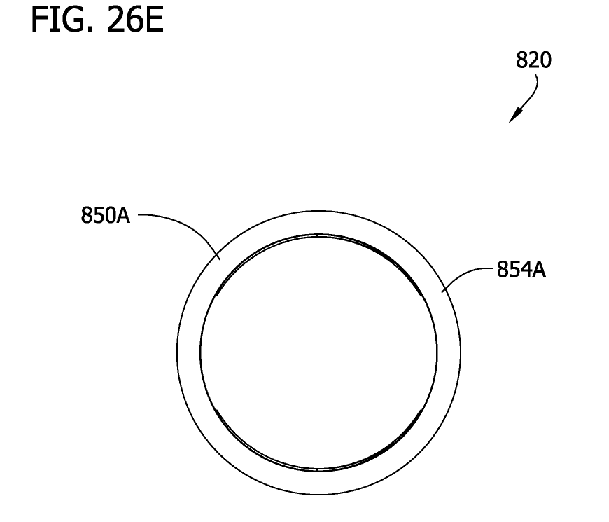

FIGS. 26A-26E illustrate various views of an eighth embodiment of a spring 820 of the present invention. The spring is similar to the spring 220 described above, and corresponding reference numbers are provided, plus 600. For example, the spring is generally cylindrical and includes upper and lower support members 850A, 850B, spring elements 852A, 852B, and upper and lower braces 854A, 854B. In this embodiment, the support members 850A, 850B and braces 854A, 854B are provided in the form of upper and lower rings. In other words, the braces 854A, 854B are not vertically offset from the support members 850A, 850B. In addition, the spring elements 852A, 852B have varying thickness along their height, and, as shown in FIG. 26E, the outer engagement surfaces of the spring elements curve more dramatically around the circumference of the spring. In this embodiment, the spring has a more truly cylindrical outer profile. Structure provided on an actuator used with this spring 820 for limiting bulging of the spring elements 852A, 852B radially outward may be suitably curved to conform to the more dramatically curved outer engagment surfaces of the spring elements. The design of this spring 820 requires the spring to be formed in a two-step injection molding process using a slide.

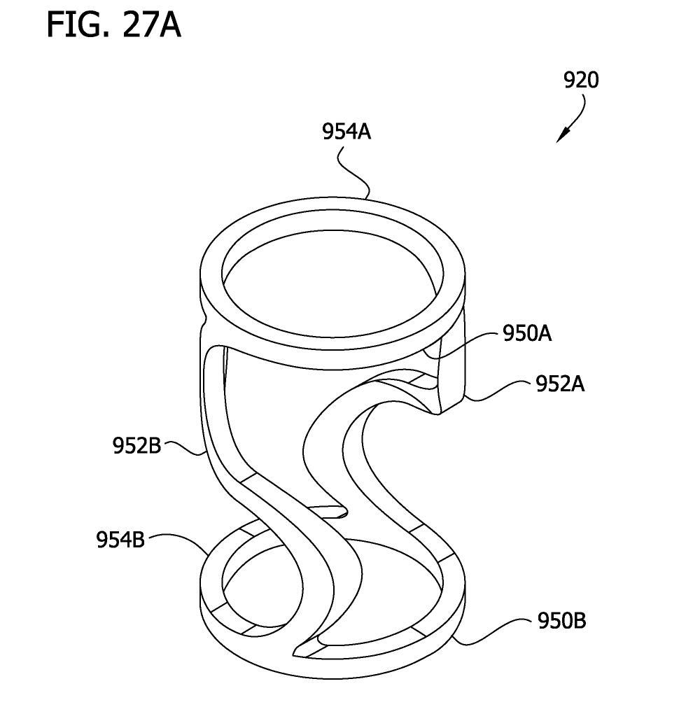

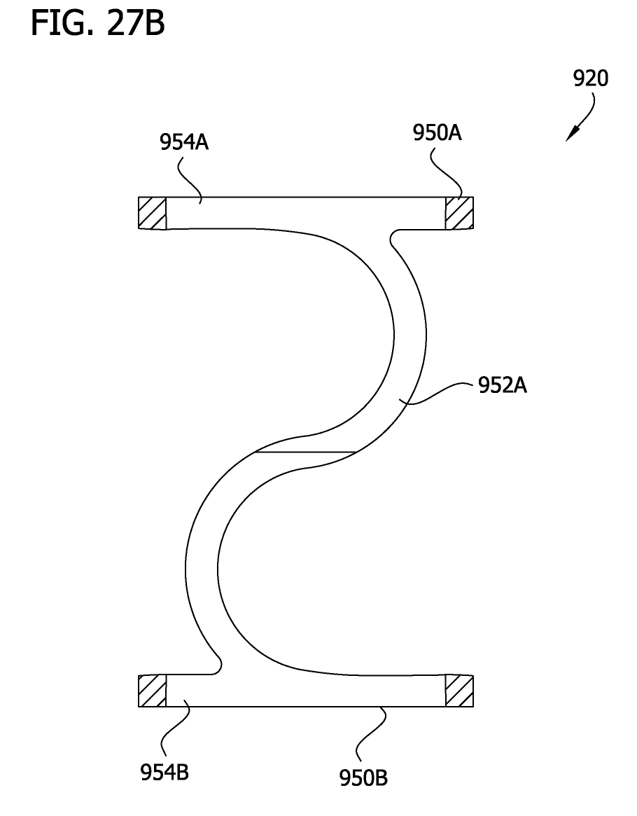

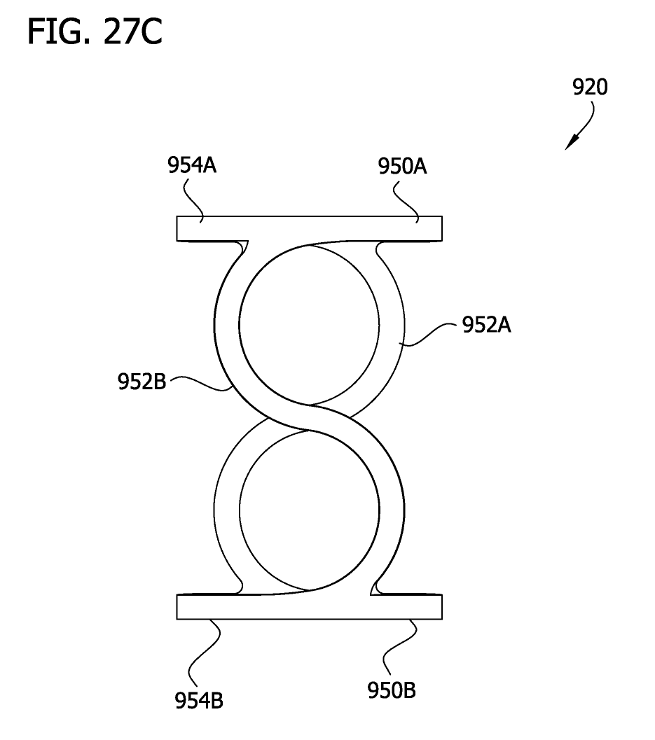

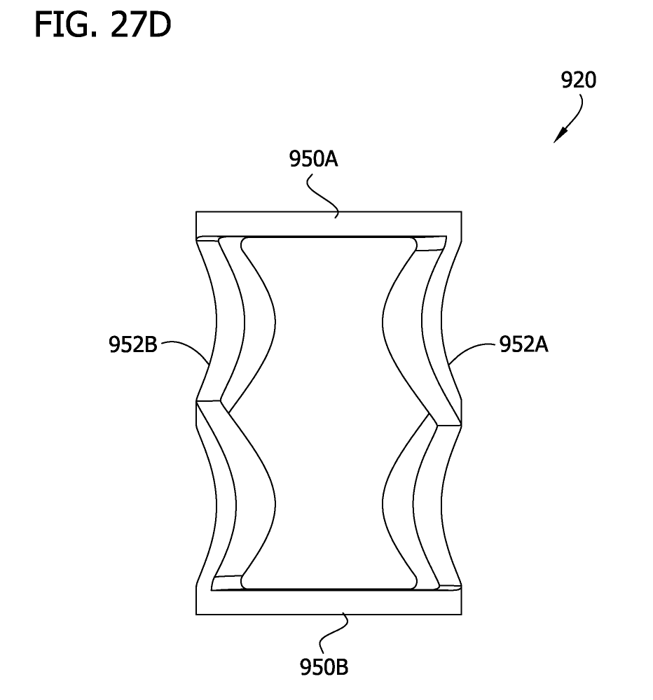

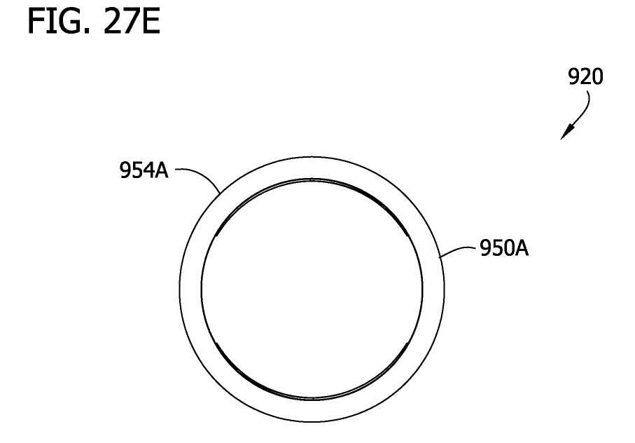

FIGS. 27A-27E illustrate various views of a ninth embodiment of a spring 920 of the present invention. The spring is similar to the spring 820 described above, and corresponding reference numbers are provided, plus 100. For example, the spring has support members 950A, 950B and braces 954A, 954B provided in the form of upper and lower rings and the spring has spring elements 952A, 952B having varying thickness along their height. In this embodiment, the spring elements 952A, 952B are provided in opposite orientations instead of symmetrical orientations. The design of this spring 920 requires the spring to be formed in a two-step injection molding process using a slide.

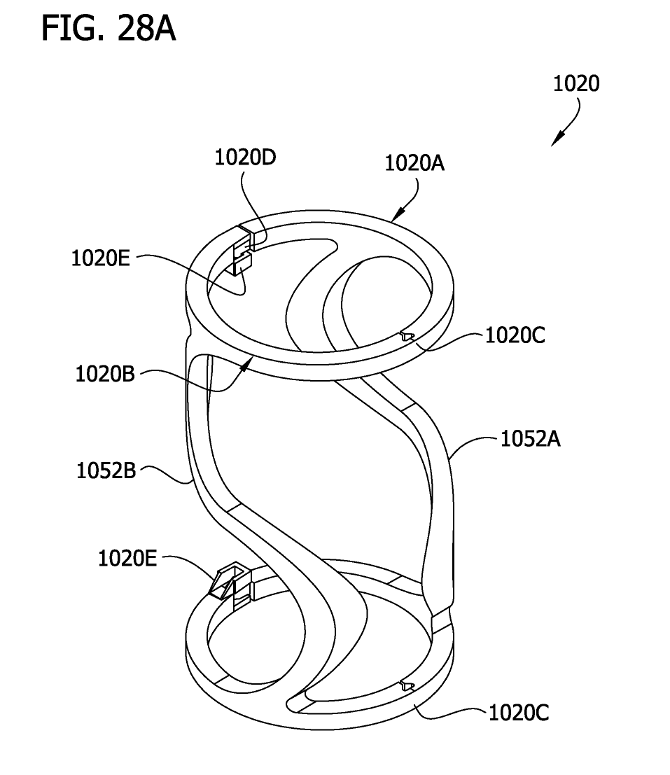

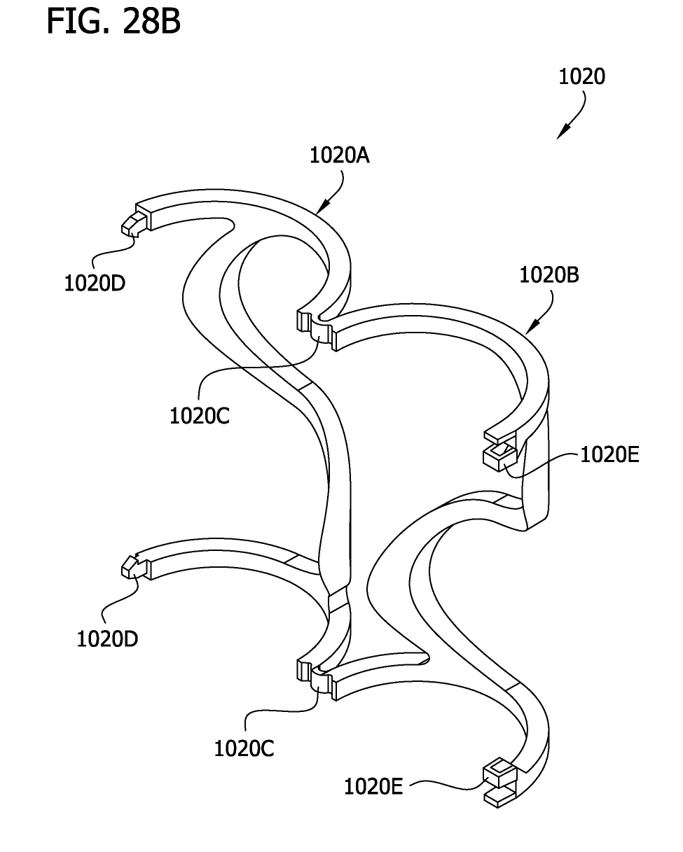

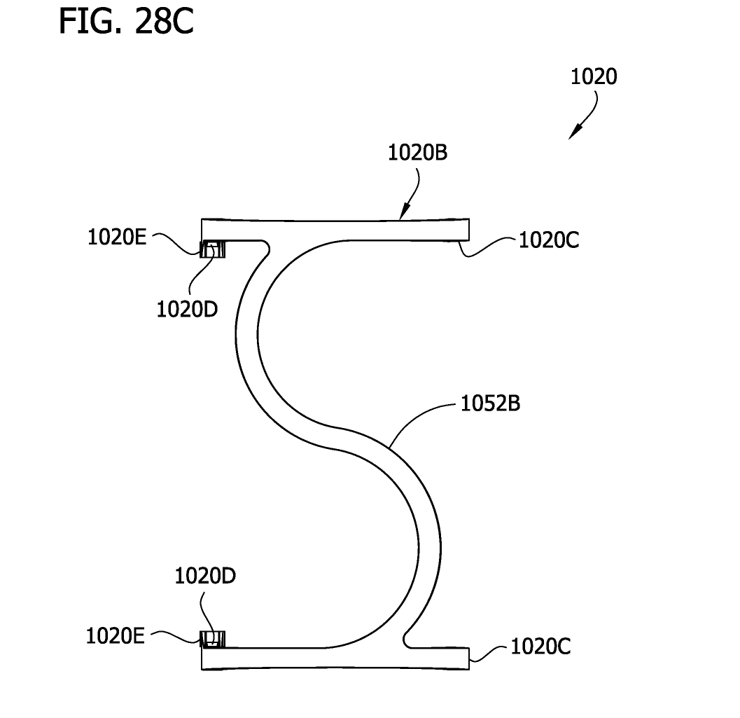

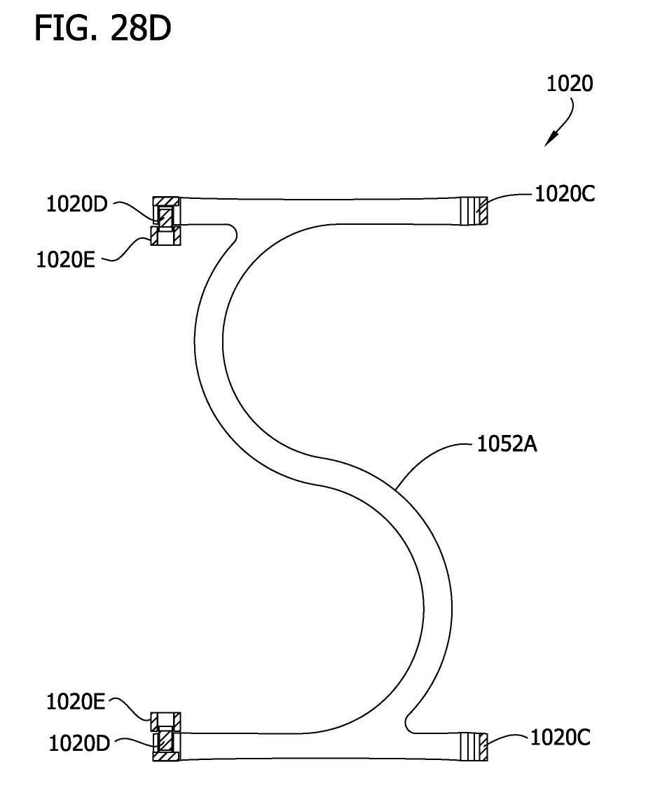

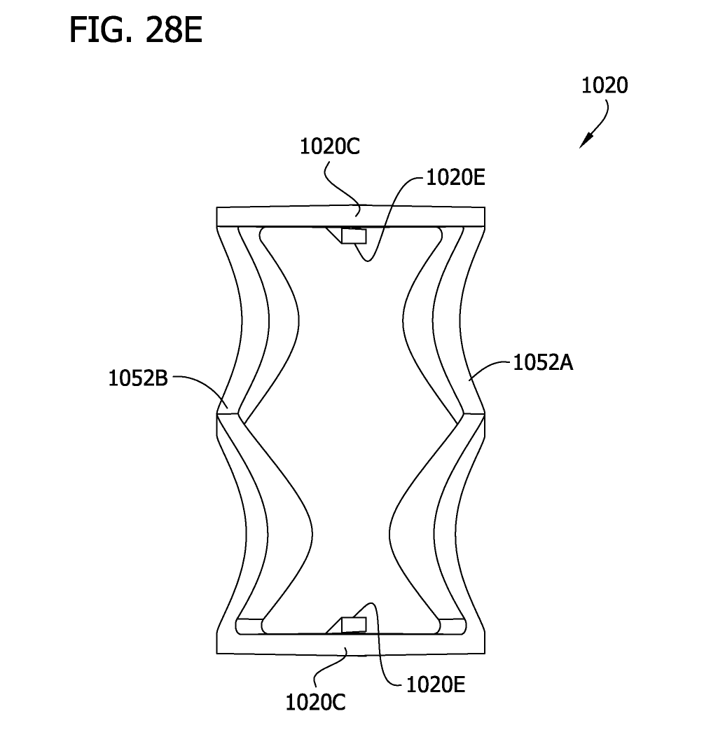

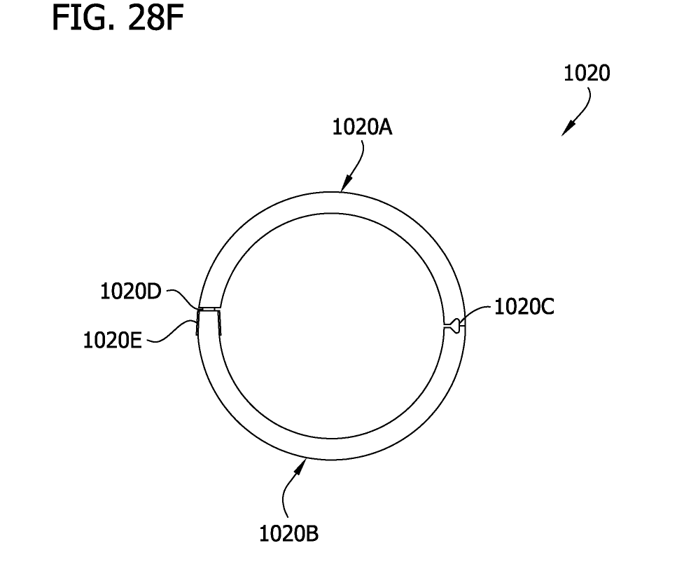

FIGS. 28A-28F illustrate various views of a tenth embodiment of a spring 1020 of the present invention. The spring is particularly similar to the spring 820 described above, and corresponding reference numbers are provided, plus 200. For example, the spring has upper and lower rings and spring elements 1052A, 1052B having varying thickness. In this embodiment, the spring 1020 is designed such that it may be formed in one close-and-open injection molding process not requiring a slide. More specifically, as shown in FIG. 28B, the spring 1020 is molded as two halves 1020A, 1020B which are pivoted toward each other about upper and lower hinges 1020C and then locked in engagement with each other by corresponding mating male and female connection structure 1020D, 1020E on respective halves.

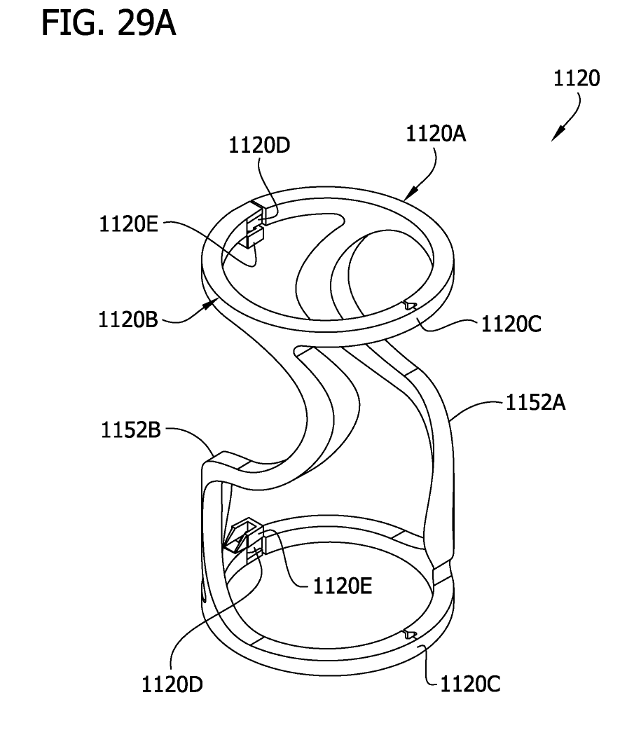

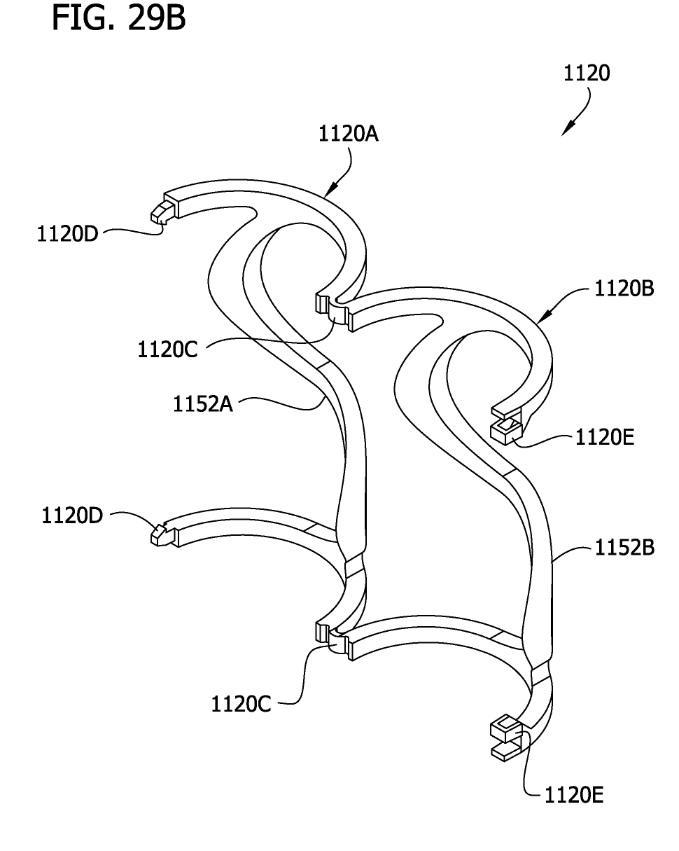

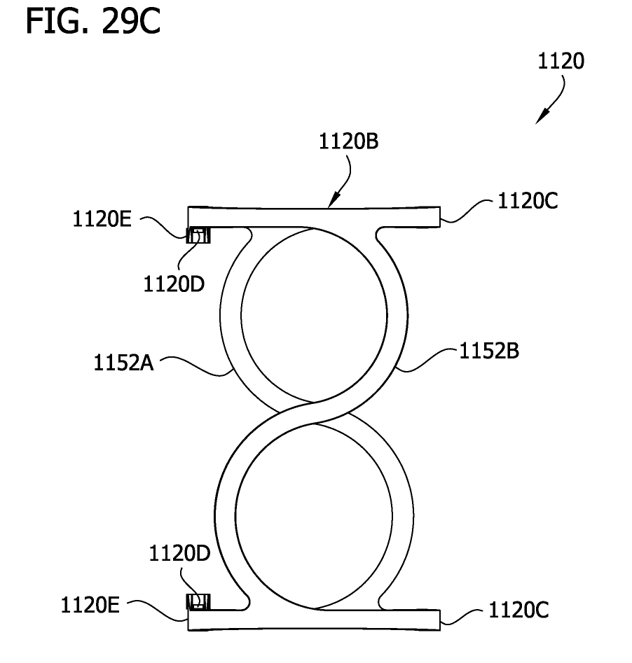

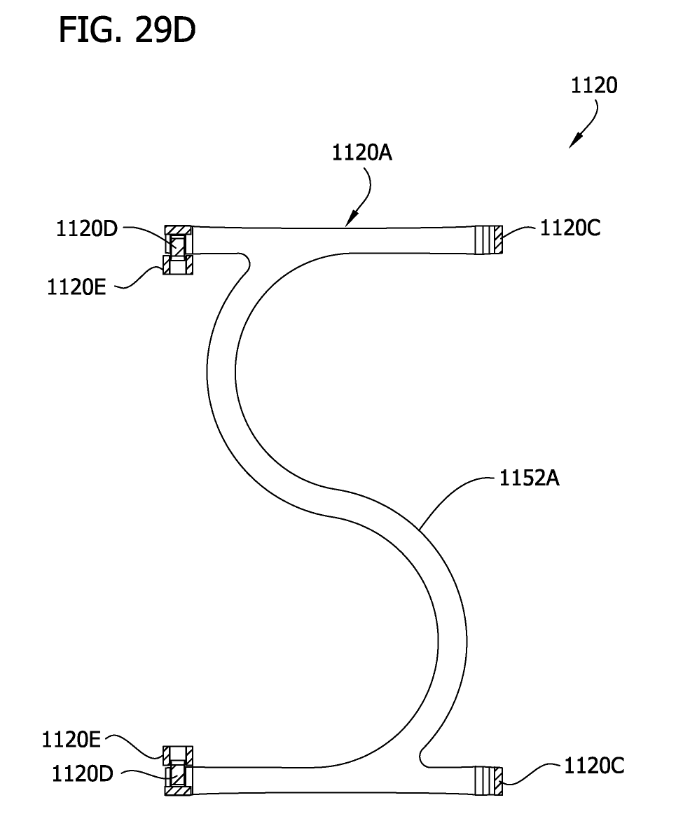

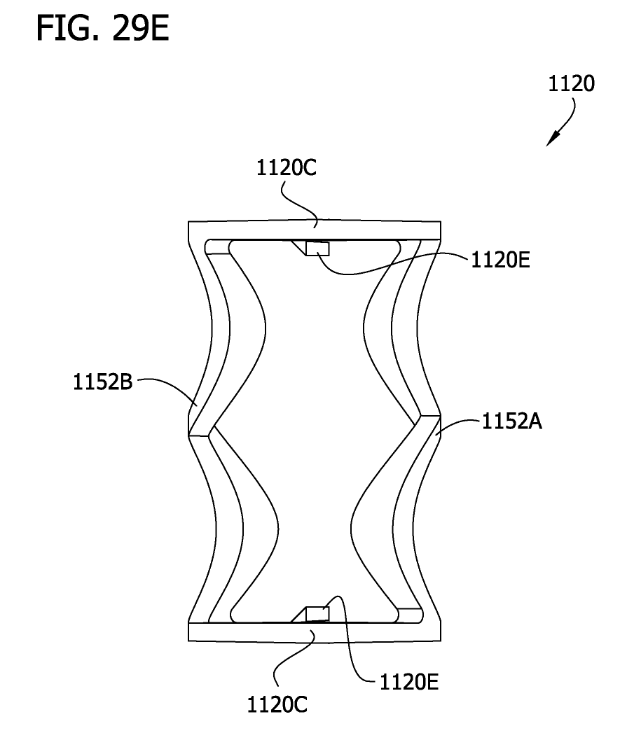

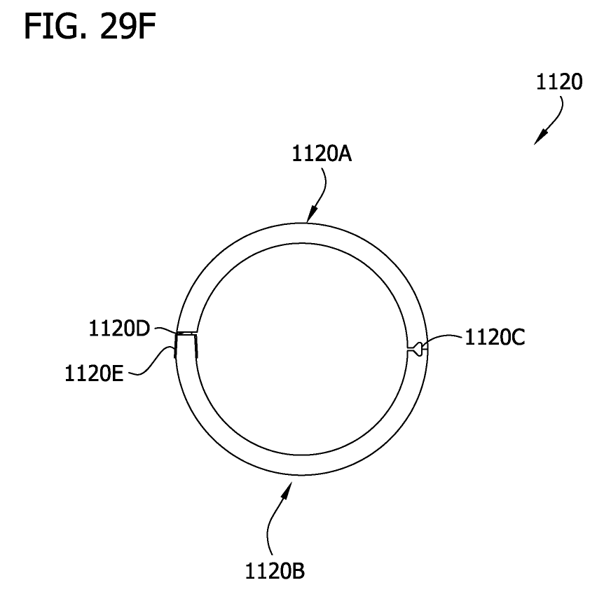

FIGS. 29A-29F illustrate various views of an eleventh embodiment of a spring 1120 of the present invention. The spring is particularly similar to the spring 920 described above, and corresponding reference numbers are provided, plus 200. For example, the spring has upper and lower rings and spring elements 1152A, 1152B having varying thickness. In addition, the spring 1120 has spring elements 1152A, 1152B having opposite orientations. In this embodiment, the spring 1120 is designed such that it may be formed in one close-and-open injection molding process not requiring a slide. More specifically, as shown in FIG. 29B, the spring 1120 is molded as two halves 1120A, 1120B which are pivoted toward each other about upper and lower hinges 1120C and then locked in engagement with each other by corresponding mating male and female connection structure 1120D, 1120E on respective halves.

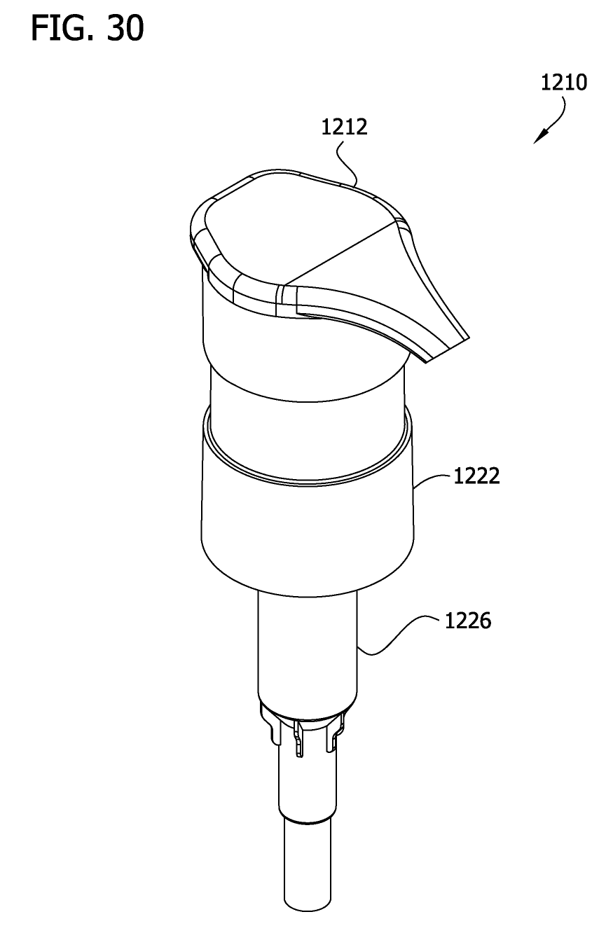

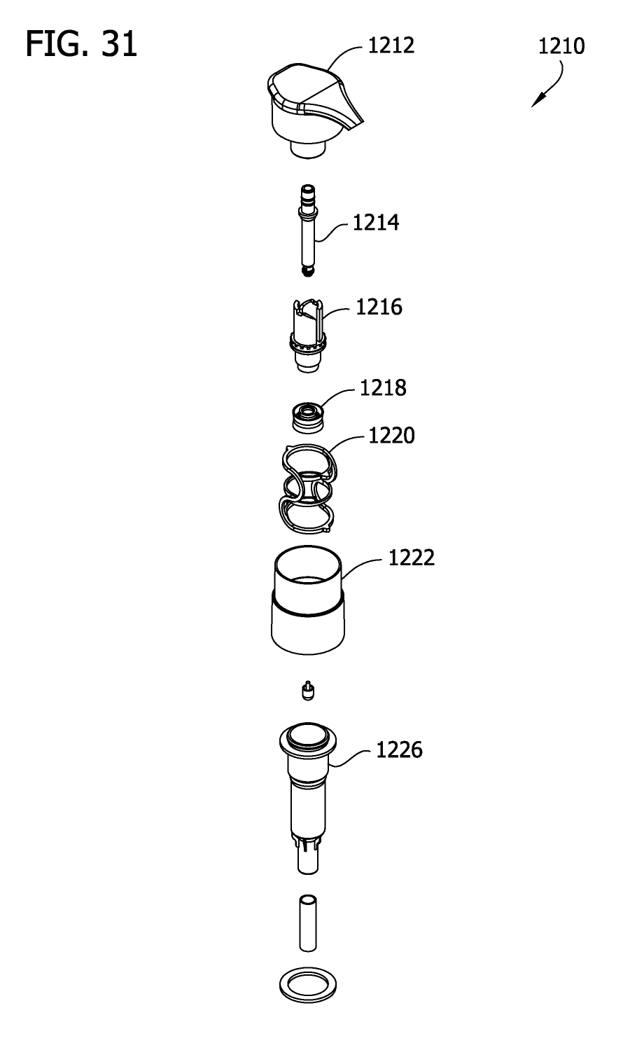

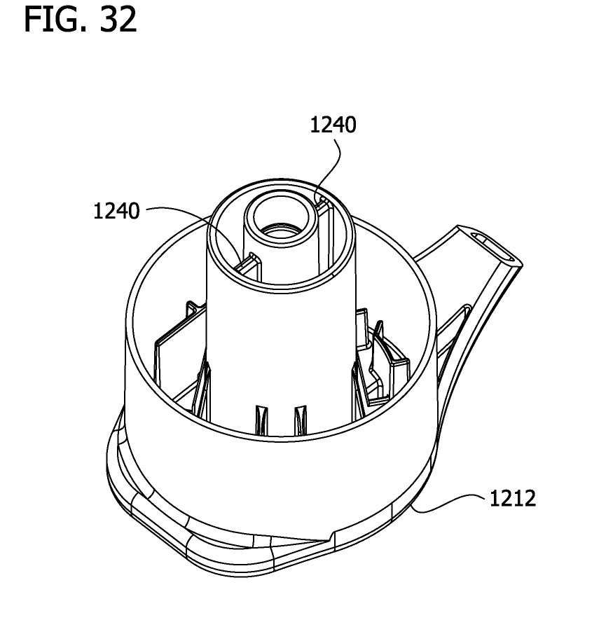

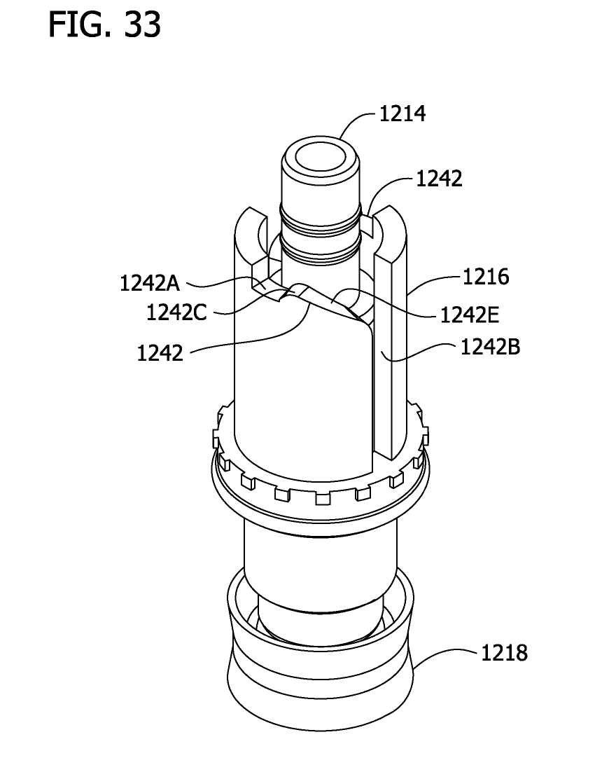

FIGS. 30-34 illustrate various views of a second embodiment of a pump of the present invention. The pump is similar to the pump 10 described above, and corresponding reference numbers are provided, plus 1200. For example, as shown in FIG. 31, the pump 1210 includes an actuator 1212, a piston shaft 1214, a chaplet 1216, a piston member 1218, a compression spring 1220, a reservoir cap 1222, and a housing 1226. As in the first embodiment, the actuator 1212 and the chaplet 1216 include cooperating structure which “locks” the pump 1210 when the actuator is in the locked position and “unlocks” the pump when the actuator is in the unlocked position. As shown in FIG. 32, the actuator 1212 includes ribs 1240 extending radially outward from a vertical axis of the actuator. As shown in FIG. 33, the chaplet 1216 includes opposite contoured upward facing surfaces 1242, for engaging the ribs 1240 of the actuator 1212. Each contoured surface 1242 includes a first portion or notch 1242A in which a respective rib 1240 is received when the actuator 1212 is in the locked position, a second portion or slot 1242B in which the rib is received when the actuator is in the unlocked position, and a detent 1242C adjacent the notch. In this embodiment, the contoured surfaces 1242 each include a ramp or camming surface 1242E between the slot 1242B and the notch 1242A. The camming surface 1242E includes an upper end adjacent the notch 1242A and a lower end adjacent the slot 1242B. The camming surface 1242E ramps upward from the lower end to the upper end, and the lower end is lower than the notch 1242A. As explained in further detail below, the camming surfaces 1242E assist in preventing the spring 1220 from reducing in length after repeated compression cycles.

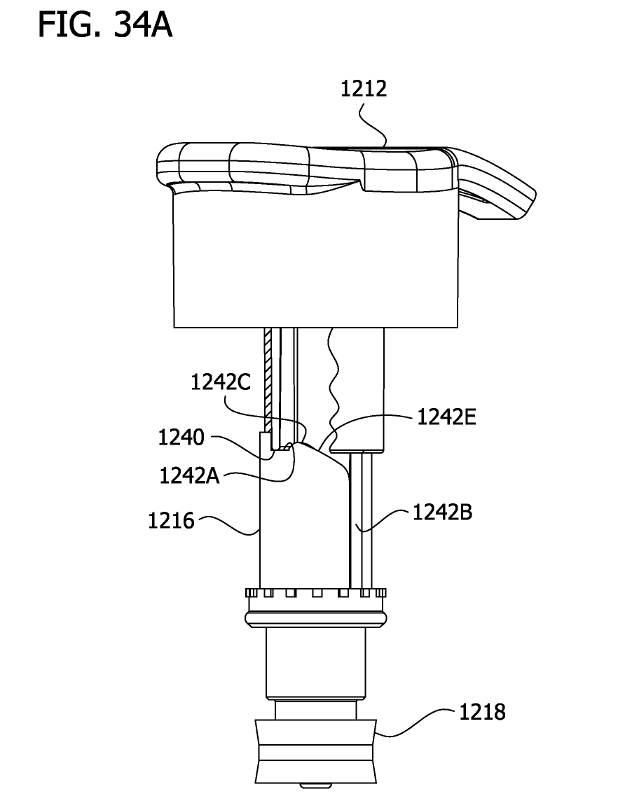

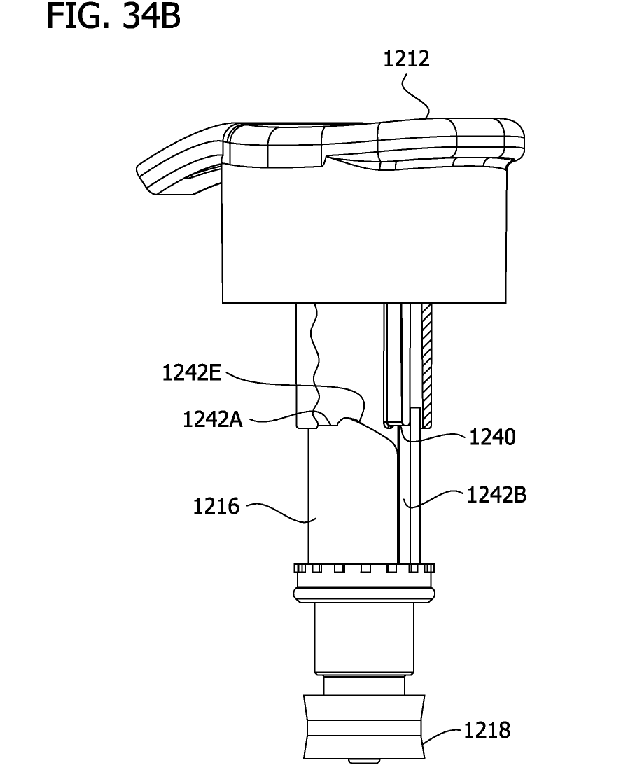

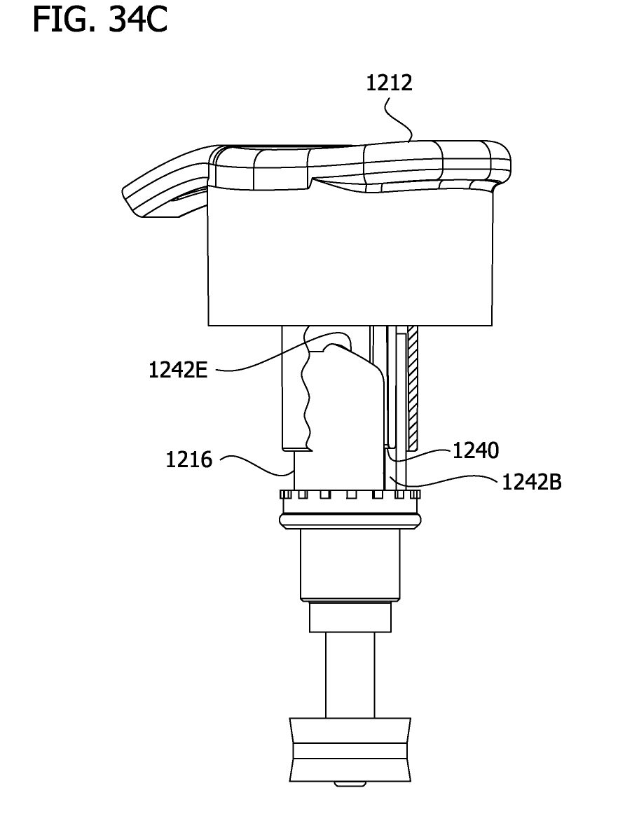

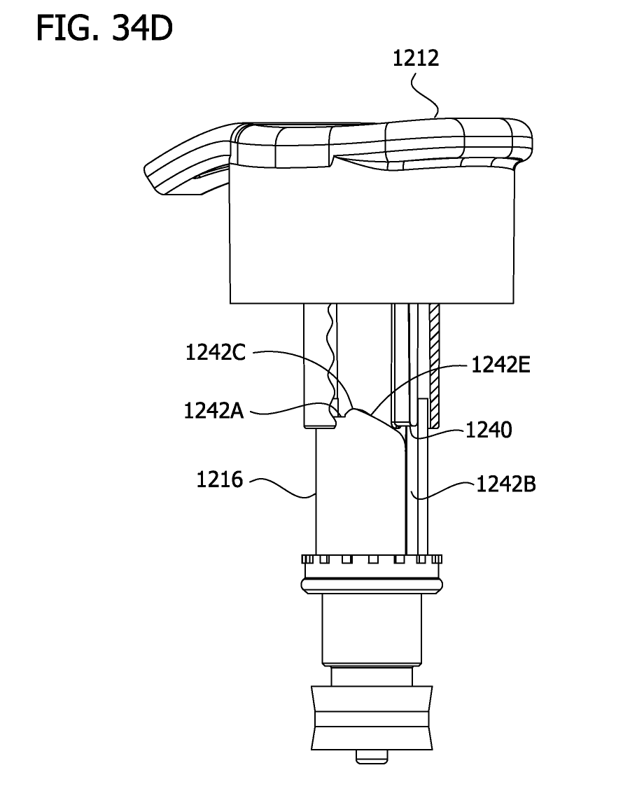

FIG. 34A shows the actuator 1212 on the chaplet 1216 and the actuator being in the locked position. A rib 1240 of the actuator 1212 is shown received the notch 1242A of the chaplet 1216. A portion of the lower part of the actuator 1212 is broken away to expose the rib 1240. FIG. 34B shows the actuator 1212 rotated to the unlocked position in which the rib 1240 is in register with the slot 1242B. The rib 1240 is shown at a height relative to the chaplet 1216 about the same as FIG. 34A when the actuator was in the locked position. The rib 1240 is supported in this vertical position by the bias of the compression spring 1220.

FIG. 34C shows the actuator 1212 moved to the actuated position. The rib 1240 is received in the slot 1242B at a vertical position lower than in the unactuated position. As the actuator 1212 is moved downward to this position, fluid is moved through the pump 1210. When the user releases pressure on the actuator 1212, the spring 1220 desirably raises the actuator back to its unactuated position such as shown in FIG. 34B. Over time, multiple compression cycles may cause the compression spring 1220 to become less resilient or reduce in length. This may result in the spring 1220 supporting the rib 1240 of the actuator 1212 at a lower position with respect to the chaplet 1216 than when the spring 1220 was in a new condition. For example, the spring 1220 after numerous compression cycles may support the actuator 1212 at a height such as shown in FIG. 34D in which the rib 1240 is lower than shown in FIG. 34B.

The camming surfaces 1242E facilitate locking of the pump 1210 after the spring 1220 has become less resilient and/or decreased in length. Moreover, the camming surfaces 1242E assist in preventing the spring 1220 from losing resiliency or reducing in length and may actually restore some resiliency or length to the spring. When the spring 1220 has decreased in length or resiliency such that it supports the actuator 1212 in a lower position than the spring was originally capable, the camming surface 1242E permits the user to rotate the actuator to the locked position by applying a rotational force to the actuator. Without the camming surface 1242E, pure rotational movement of the actuator may be blocked by engagement of the rib 1240 with the side of the slot 1242B. In other words, if the spring 1220 is not strong enough to support the rib 1240 at a position above the slot 1242B instead of in the slot 1242B, the user would need to raise the actuator 1212 (to lift the rib 1240 upward out of the slot 1242B) before rotating the actuator to the locked position. The camming surface 1242E compensates for reduction in length of the spring by raising the rib 1240 as the actuator 1212 is rotated toward the locked position. As long as the spring 1220 is strong enough to support the actuator at a height at which the rib 1240 is above the lower end of the camming surface 1242E, a user may rotate the actuator to the locked position without lifting the actuator to raise the rib out of the slot 1242B. Desirably, when the actuator 1212 is in the locked position, compression is relieved from the spring 1220. This reduction in load on the spring 1220 assists in preventing length reduction of the spring. If the bottom end of the spring 1220 is prevented from moving upward (e.g., connected to a component of the pump 1210), the spring 1220 may even be tensioned when the actuator 1212 is in the locked position, which may restore length and/or resiliency to the spring.

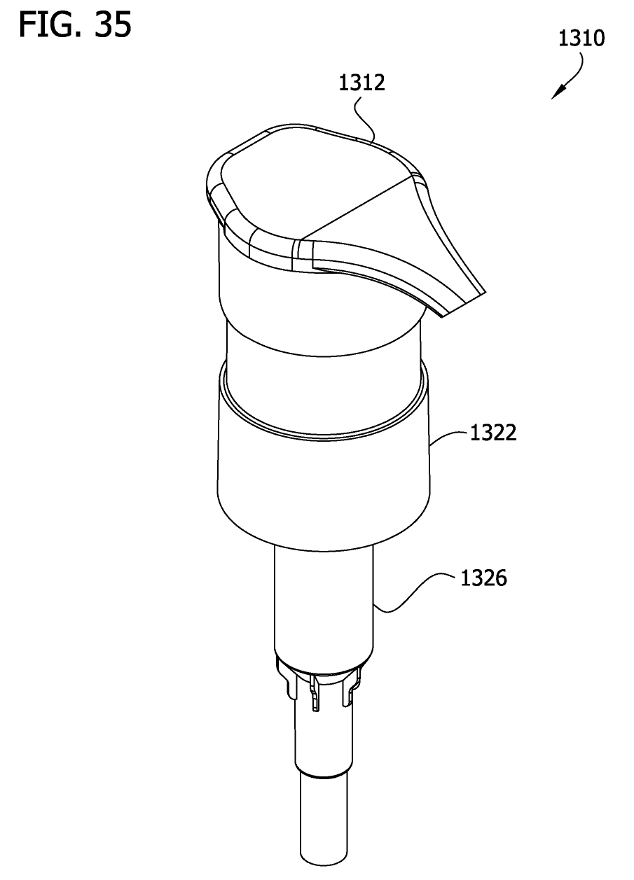

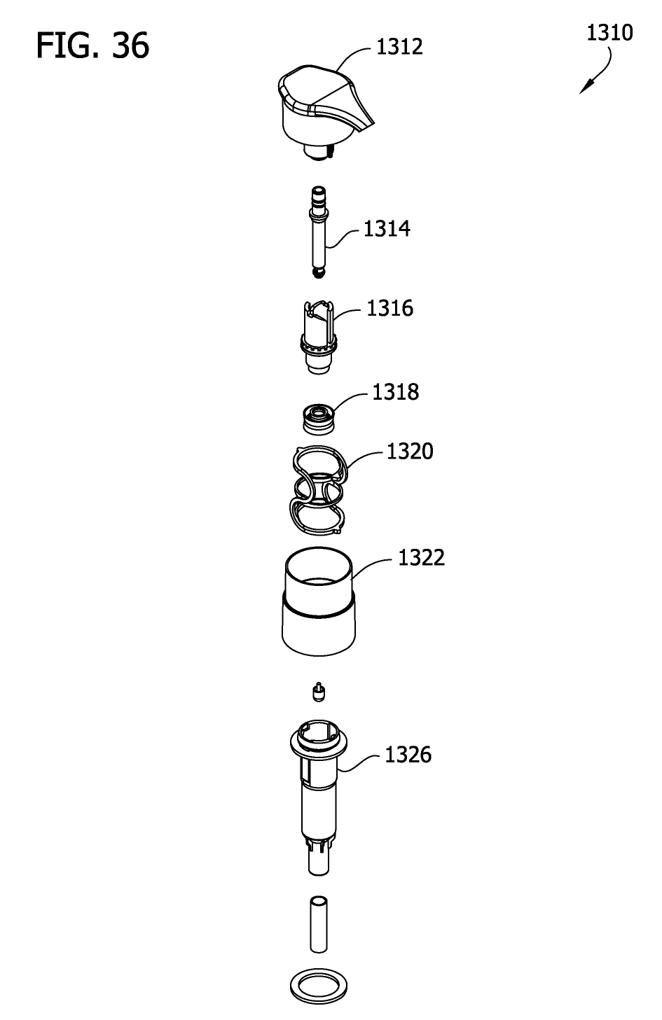

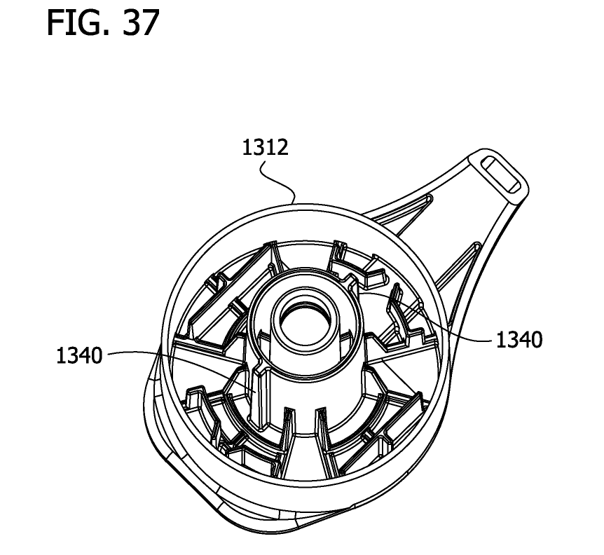

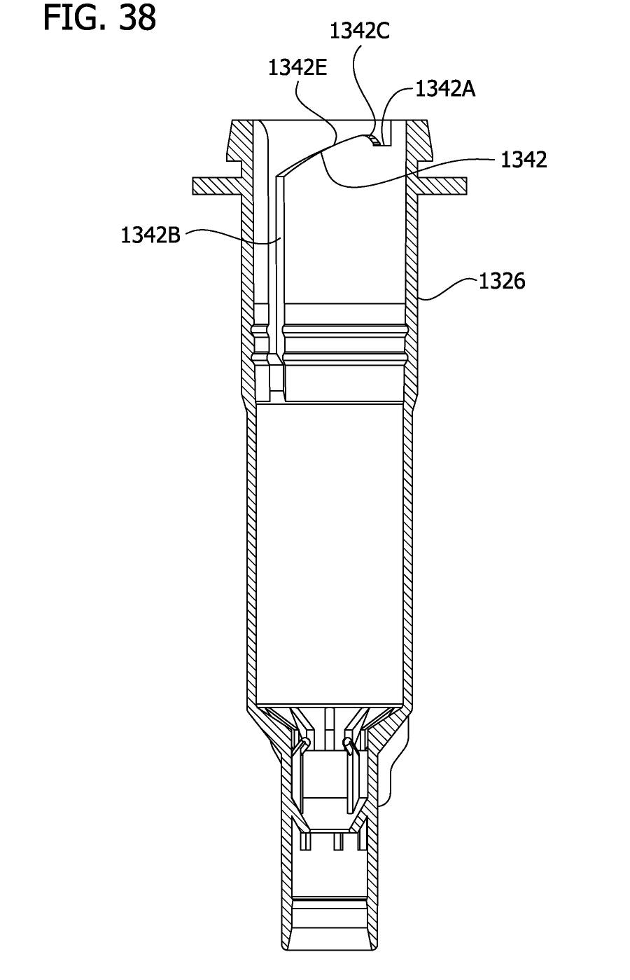

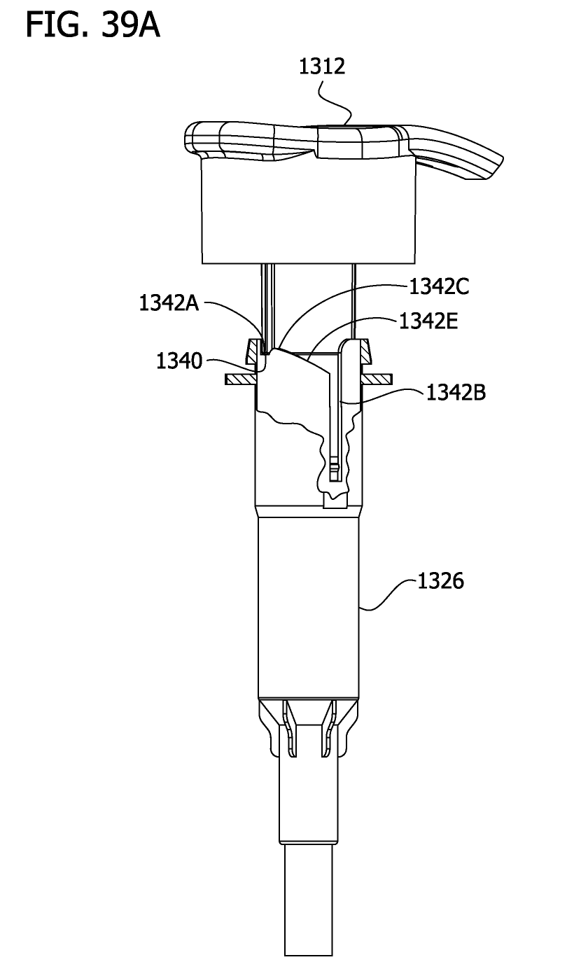

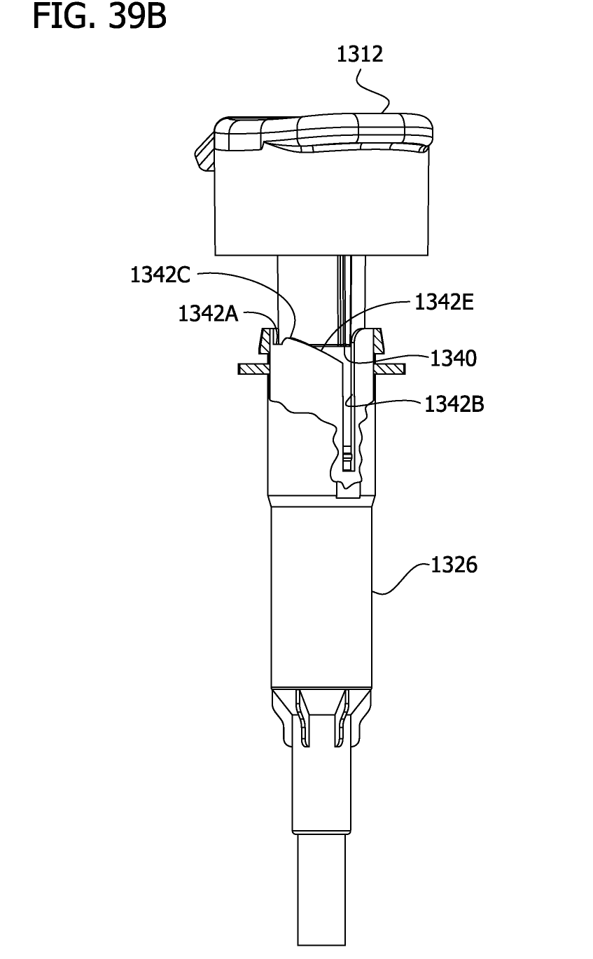

FIGS. 35-39 illustrate various views of a third embodiment of a pump 1310 of the present invention. The pump is similar to the pump 10 described above, and corresponding reference numbers are provided, plus 1300. For example, as shown in FIG. 36, the pump 1310 includes an actuator 1312, a piston shaft 1314, a chaplet 1316, a piston member 1318, a compression spring 1320, a reservoir cap 1322, and a housing 1326. In this embodiment, the actuator 1312 and housing 1326 include cooperating structure which “locks” the pump 1310 when the actuator is in the locked position and “unlocks” the pump when the actuator is in the unlocked position. The cooperating structure is substantially similar to the cooperating structure on the pump 1210 but is provided on different components of the pump 1310. As shown in FIG. 37, the actuator 1312 includes ribs 1340 extending along the height of the actuator, generally parallel the vertical axis of the actuator. As shown in FIG. 38, the housing 1326 includes inner contoured surfaces 1342 on opposite sides of the housing corresponding to each of the ribs 1340. The bottom ends of the ribs 1340 engage the contoured surfaces 1342 as the actuator 1312 is rotated between the locked and unlocked positions. Each contoured surface 1342 includes a notch 1342A, a slot 1342B, a detent 1342C adjacent the notch, and a camming surface 1342E between the notch and slot. The interaction between the ribs 1340 and the contoured surfaces 1342 is functionally identical to the interaction of the ribs 1240 and contoured surfaces 1242 in the second embodiment of the pump 1210 for locking and unlocking the actuator 1212. The actuator 1312 is shown in the locked position in FIG. 39A with a rib 1340 received in a notch 1342A. The housing 1326 is shown with portions broken away to expose the contoured surface 1342. The actuator 1312 is shown in the unlocked, unactuated position in FIG. 39B, with the rib 1340 in register with the slot 1342B. If the spring 1320 were to decrease in resiliency and/or reduce in length, the camming surface 1342E would facilitate rotation of the actuator 1312 from the unlocked position to the locked position by ramping the rib 1340 upward as described with respect to the pump 1210.

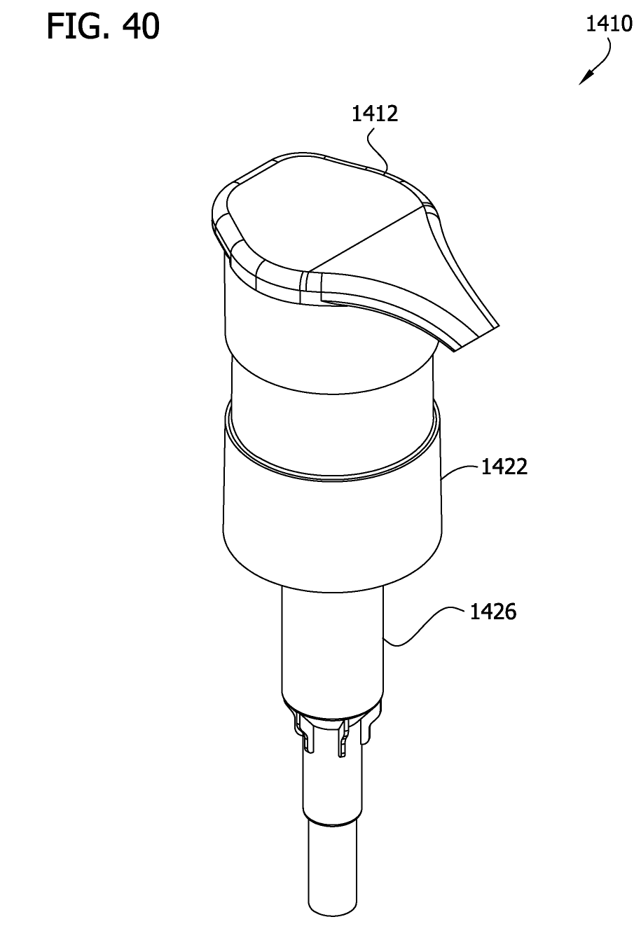

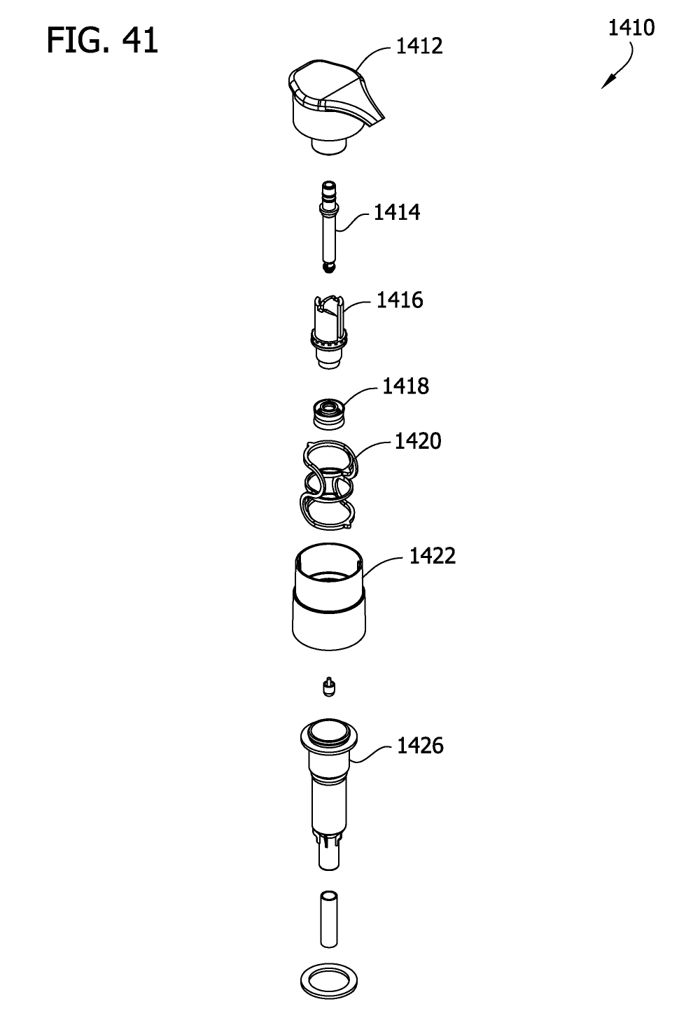

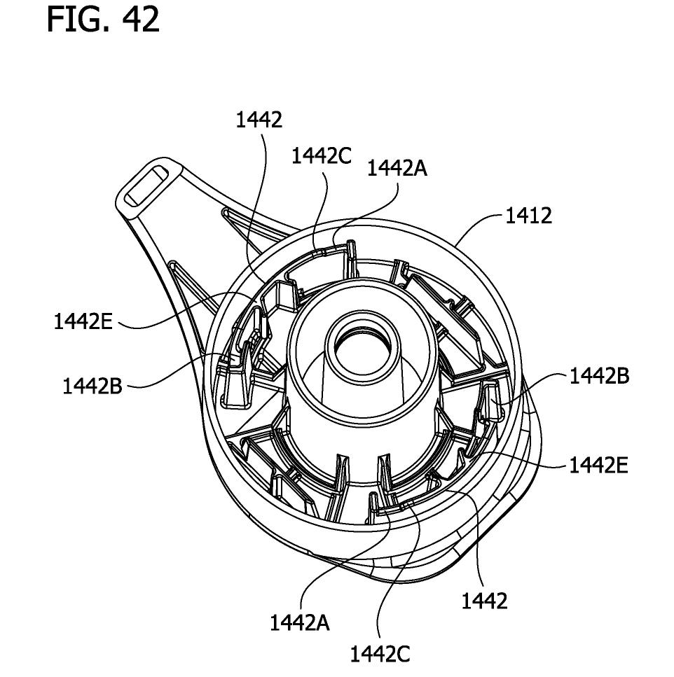

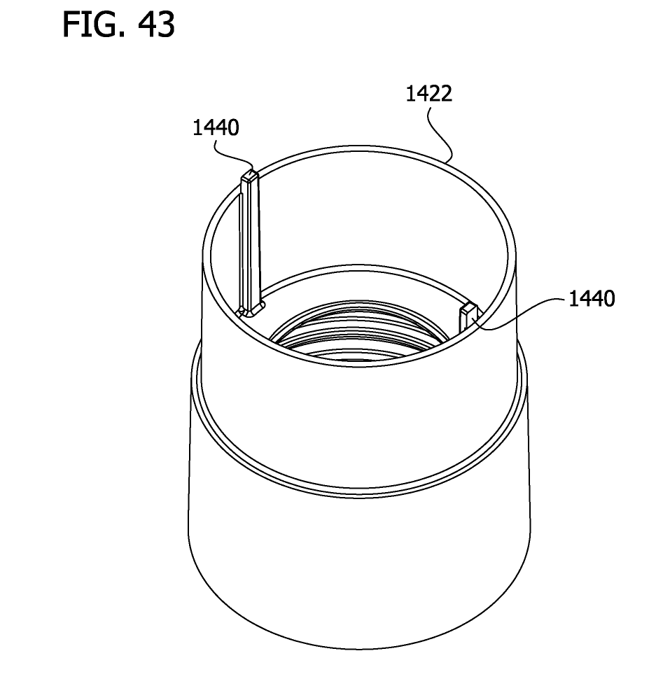

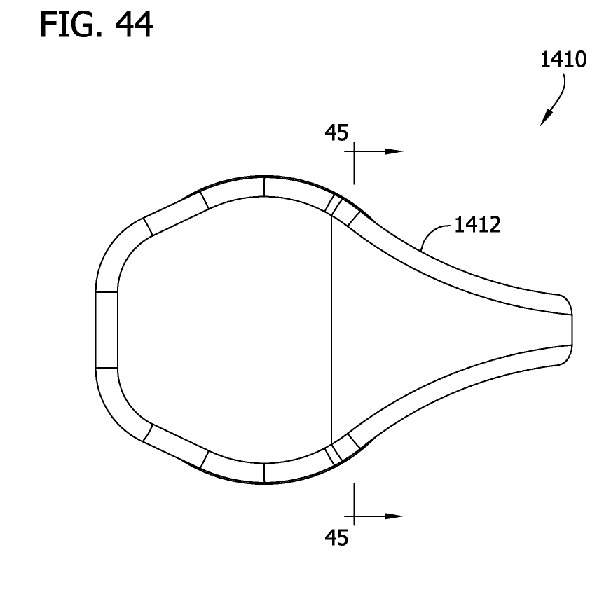

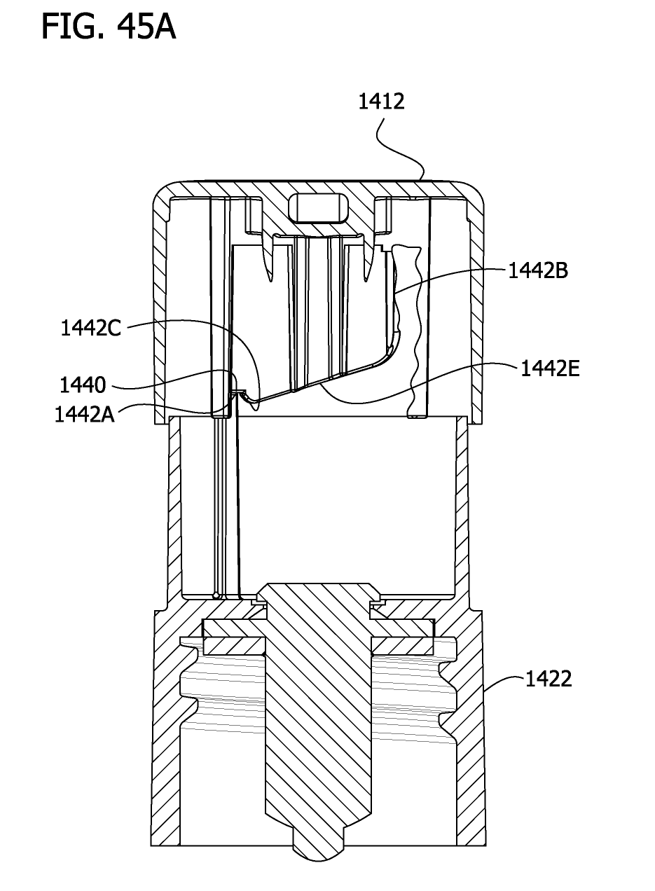

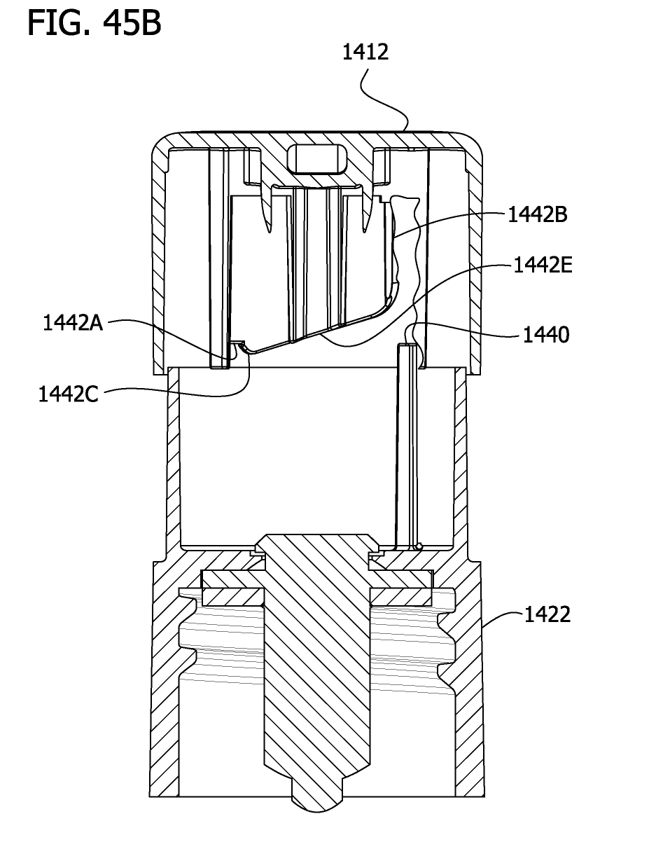

FIGS. 40-45 illustrate various views of a fourth embodiment of a pump 1410 of the present invention. The pump is similar to the pump 10 described above, and corresponding reference numbers are provided, plus 1400. For example, as shown in FIG. 41, the pump 1410 includes an actuator 1412, a piston shaft 1414, a chaplet 1416, a piston member 1418, a compression spring 1420, a reservoir cap 1422, and a housing 1426. In this embodiment, the actuator 1412 and reservoir cap 1422 include cooperating structure which “locks’ the pump 1410 when the actuator is in the locked position and “unlocks” the pump when the actuator is in the locked position. The cooperating structure is substantially similar to the cooperating structure on the pump 1210 but is provided on different components of the pump 1410. As shown in FIG. 43, the reservoir cap 1422 includes ribs 1440 extending along the height of the reservoir cap, generally parallel the vertical axis of the reservoir cap. As shown in FIG. 42, the actuator 1412 includes inner contoured surfaces 1442 on opposite sides of the actuator 1412 corresponding to each of the ribs 1440. The top ends of the ribs 1440 engage the contoured surfaces 1442 as the actuator 1412 is rotated between the locked and unlocked positions. Each contoured surface 1442 includes a notch 1442A, a slot 1442B, a detent 1442C adjacent the notch, and a camming surface 1442E between the notch and slot. The interaction between the ribs 1440 and the contoured surfaces 1442 is functionally identical to the interaction of the ribs 1240 and contoured surfaces 1242 in the second embodiment of the pump 1210 for locking and unlocking the actuator 1212. The actuator 1412 is shown in the locked position in FIG. 45A with a rib 1440 received in a notch 1442A. The actuator 1412 is shown in the unlocked, unactuated position in FIG. 45B, with the rib 1440 in register with the slot 1442B and a portion of the actuator broken away to expose the slot. If the spring 1420 were to decrease in resiliency and/or reduce in length, the camming surface 1442E would facilitate rotation of the actuator 1412 from the unlocked position to the locked position as described with respect to the pump 1210.

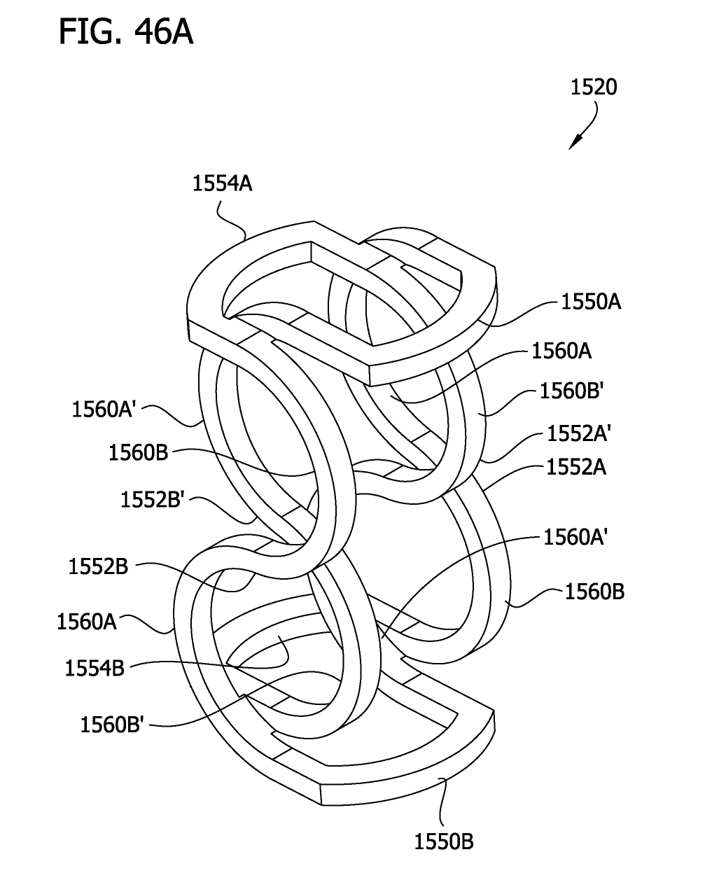

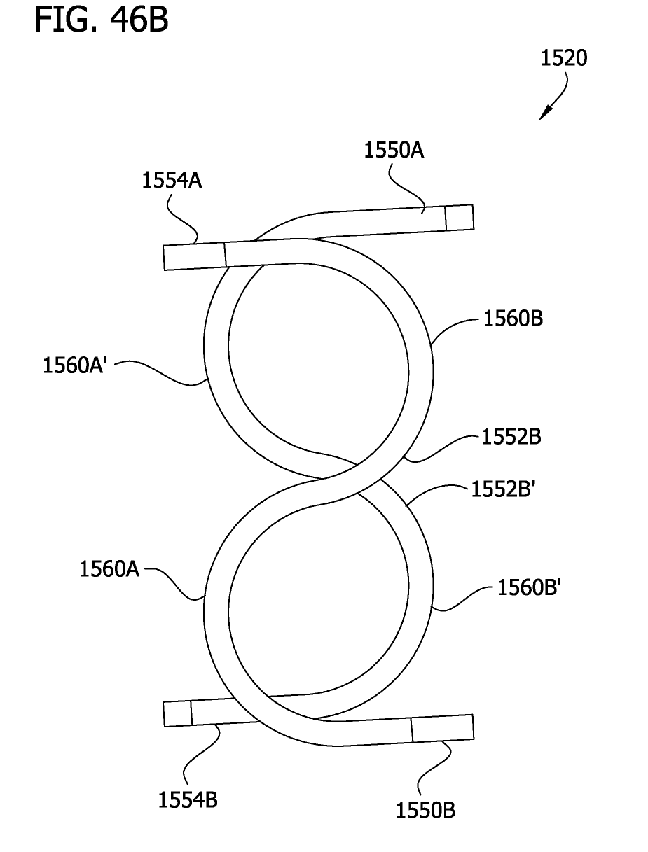

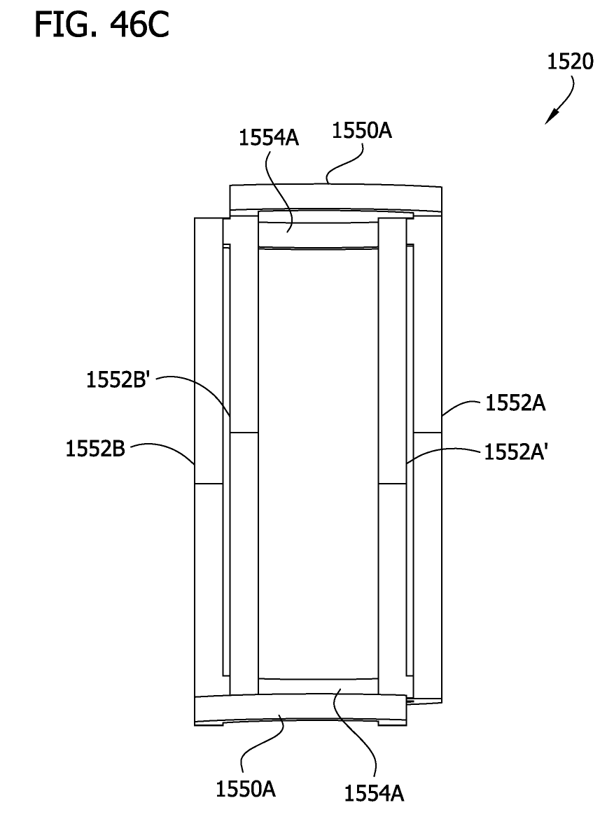

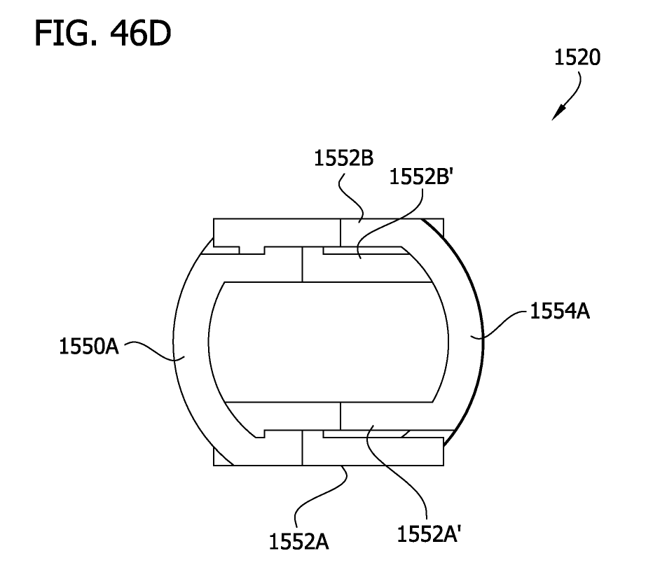

FIGS. 46A-46D illustrate another embodiment of a spring 1520 of the present invention. Although the spring 1520 is not illustrated as part of a pump, it will be understood the spring may be combined with pump components such as those disclosed herein for forming a pump according to the present invention. The spring 1520 is similar to the spring 220 described above, and corresponding reference numbers are provided, plus 1300. For example, the spring 1520 is generally cylindrical and includes upper and lower support members 1550A, 1550B, (first and second) spring elements 1552A, 1552B extending between the support members at first and second ends of the spring 1520. Upper and lower braces 1554A, 1554B extend between the spring elements 1552A, 1552B′ and 1552B, 1552A′. The support members 1550A, 1550B and braces 1554A, 1554B may be broadly considered “connecting members.” In this embodiment, the spring 1520 also includes secondary (third and fourth) spring elements 1552A′, 1552B′ extending between the support members inboard of the spring elements 1552A, 1552B to form respective pairs of spring elements on each side of the spring. The spring elements 1552A, 1552B, 1552A′, 1552B′ are shown as generally S-shaped, but may have other shapes, such as a “Z” shape. As shown in FIGS. 46A and 46C, the spring elements 1552A, 1552A′ and 1552B, 1552B′ are connected to each other at spaced apart locations adjacent the top and bottom of the spring. However, as shown in FIG. 46B, the spring elements 1552A, 1552A′ and 1552B, 1552B′ are free from connection from each other along intermediate portions of the spring elements. The spring elements 1552A, 1552A′ and 1552B, 1552B′ each have similar configurations but are positioned in opposite orientations. The first and second concave segments of curvature 1560A, 1560B, of the spring elements 1552A, 1552B face in generally opposite first and second directions of the segments of curvature 1560A′, 1560B′ of the secondary spring elements 1552A′, 1552W. In other words, the spring elements 1552A, 1552B, 1552A′, 1552B′ of each pair are substantially mirror images of each other. As shown in FIG. 46B, the spring elements 1552A, 1552A′ and 1552B, 1552B′ each form a FIG. 8 shape when viewed from the side. The pairs of spring elements 1552A, 1552A′, 1552B, 1552B′ may provide the spring 1520 with greater balance (e.g., the spring does not tend to tilt off of its longitudinal axis) in response to compression forces and may increase the force required for compressing the spring 1520.

As viewed from the top (FIG. 46D), it may be seen that the spring elements 1552A, 1552B, 1552A′, 1552B′ are positioned closer to the vertical centerline of the spring 1520 to improve strength of the spring. Preferably, the spring elements 1552A, 1552B, 1552A′, 1552B′ are brought as close to the vertical centerline as possible while maintaining clearance for structure received through the center of the spring 1520. As viewed from the top, the perimeter of the spring is non-circular. The spring elements 1552A′, 1552B′ are located within the smallest circle that contains the perimeter of the spring 1520 (as viewed from the top).

Having described the invention in detail, it will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

1. A spring comprising:
a first spring element extending between first and second ends of the spring on a first side of the spring, the first spring element defining a first concave segment opening in a first direction;
a second spring element extending between the first and second ends of the spring on a second side of the spring, the second spring element defining a first concave segment opening in a second direction generally opposite the first direction.

2. A spring as set forth in claim 1 further comprising:
a third spring element on the first side of the spring, the third spring element defining a first concave segment opening in the second direction;
a fourth spring element on the second side of the spring, the fourth spring element defining a first concave segment opening in the first direction.

3. A spring as set forth in claim 2 wherein:
the first spring element defines a second concave segment opening in the second direction;
the second spring element defines a second concave segment opening in the first direction;
the third spring element defines a second concave segment opening in the first direction;
the fourth spring element defines a second concave segment opening in the second direction.

4. A spring as set forth in claim 2 wherein the third and fourth spring elements extend between the first and second ends of the spring.

5. A spring as set forth in claim 2 wherein the first and third spring elements are connected to each other at spaced apart locations and the second and fourth spring elements are connected to each other at spaced apart locations.

6. A spring as set forth in claim 2 further comprising a first connecting member connecting the first spring element to the fourth spring element and a second connecting member connecting the second spring element to the third spring element.

7. A spring as set forth in claim 6 wherein the first and second connecting members are located at the first end of the spring.

8. A spring as set forth in claim 7 further comprising a third connecting member connecting the first spring element to the fourth spring element and a fourth connecting member connecting the second spring element to the third spring element.

9. A spring as set forth in claim 8 wherein the third and fourth connecting members are located at the second end of the spring.

10. A spring as set forth in claim 1 wherein the second side of the spring is opposite the first side of the spring.

11. A spring comprising:
upper and lower support members defining respective upper and lower bearing surfaces;
at least first and second spring elements extending between the upper and lower support members; and
at least one brace connecting the first spring element to the second spring element.

12. A spring as set forth in claim 11 wherein the brace is positioned along the height of the first and second spring elements such that the brace is below the upper support member and above the lower support member.

13. A pump for dispensing fluid, the pump comprising a spring and structure which houses the spring, the spring including spring elements having side engagement surfaces, and the structure having corresponding engagement surfaces for engaging respective engagement surfaces of the spring elements for substantially preventing the spring elements from bulging radially outward when the spring elements are compressed.

14. A pump as set forth in claim 13 wherein the structure which houses the spring includes an actuator, and the actuator includes mating structure for forming a mating connection with mating structure on the spring for causing the spring to rotate conjointly with the actuator.

15. A pump as set forth in claim 13 wherein the spring comprises:
upper and lower support members defining respective upper and lower bearing surfaces; and
wherein the spring elements comprise at least first and second spring elements extending between the upper and lower support members, wherein the first and second spring elements each include segments of curvature having opposite facing concavity.

16. A pump as set forth in claim 15 wherein the first and second spring elements are non-helical.

17. A pump as set forth in claim 13 wherein the spring comprises:
upper and lower support members defining respective upper and lower bearing surfaces;
wherein the spring elements comprise at least first and second spring elements extending between the upper and lower support members; and
wherein the spring further comprises at least one brace connecting the first spring element to the second spring element.

18. A pump as set forth in claim 17 wherein the brace is positioned along the height of the first and second spring elements such that the brace is below the upper support member and above the lower support member.

19. A spring including a generally cylindrical hollow body having hinges about which opposite vertical sections of the body are pivotable toward each other to form the generally cylindrical shape of the body.

20. A method of forming a spring such as those claimed above using a single close-and-open injection molding step.

21-22. (canceled)
